(19) United States
(12) Patent Application Publication
(10) Pub. No.: US 2015/0161277 A1
(43) Pub. Date: Jun. 11, 2015

(54) METHODS AND SYSTEMS FOR ONE BROWSER VERSION TO USE A RENDERING ENGINE OF ANOTHER BROWSER VERSION FOR DISPLAYING INFORMATION

(71) Applicants: Matthew Heller, Washington, DC (US); Matthew Crowley, Parma, OH (US)

(72) Inventors: Matthew Heller, Washington, DC (US); Matthew Crowley, Parma, OH (US)

(73) Assignee: BROWSIUM, INC., Redmond, WA (US)

(21) Appl. No.: 14/004,984

(22) PCT Filed: Mar. 14, 2012
(86) PCT No.: PCT/US2012/029031

§ 371 Date: Dec. 19, 2014

Related U.S. Application Data
(60) Provisional application No. 61/452,490, filed on Mar. 14, 2011.

(51) Int. Cl. G06F 17/30; G06F 17/22

(52) U.S. Cl. CPC G06F 17/30873; G06F 17/2288

(57) ABSTRACT

Methods and systems for enhancing functionality of a browser application are discloses. In an embodiment, a method enhances browser functionality using a browser add-on which enables the browser application to render web pages and other mark-up language documents or browser-rendered documents, images, audio or multimedia files that are at least in part incompatible with the current generation of browser. The add-on uses the rendering engine of prior versions of the browser and overlays their rendered image of the current generation of browser. In this way, enterprises do not have to update or upgrade web-based applications and websites do not have to necessarily upgrade the website to meet or be compatible with the current generation of browsers. In another embodiment, an enhanced browser module renders requested resources based on a DOCTYPE, inherent and/or derived properties, or metadata present within a document or related to the resource's location or its delivery stream.

### CROSS-REFERENCE TO RELATED APPLICATIONS

The present application claims the benefit of U.S. Provisional Appl. No. 61/452,490 entitled “Methods and Apparatus for One Browser Version to Use Rendering Engine of Another Browser Version for Displaying Information,” filed Mar. 14, 2011. This prior application is incorporated by reference herein in its entirety.

### FIELD OF THE DISCLOSURE

The field of the disclosure relates generally to a network browser, and more particularly to a browser capable of rendering web pages or web-based applications with an optimal rendering engine for the webpage or application.

### DESCRIPTION OF THE RELATED ART

Web (or Internet) browsers are software applications that retrieve, comprehend and locate information resources on a network such as the World Wide Web. Information resources are identified by a uniform resource identifier (URI), a sub-category of which is a uniform resource locator (URL). The information resource might be a webpage, an image, a video, a browser-based software application or other piece of content. Although browsers are primarily intended to access network resources, they can also be used to access information provided by servers and private networks or files in a file system. Some browsers can be used to save information resources in file systems. Examples of more common browsers include MICROSOFT™ Internet Explorer (IE), MOZILLA Firefox, GOOGLE™ Chrome, APPLE Safari, and OPERA™.

A web browser process begins when the user inputs a Uniform Resource Identifier (URI), for example http://en.example.com/, into the browser. The prefix of the URI determines how the URI will be interpreted, e.g., “http:”, which identifies a resource to be retrieved over the Hypertext Transfer Protocol (HTTP). Other prefixes include, e.g., https: for HTTPS (HTTP secure), ftp: for the File Transfer Protocol, and file: for local files. Prefixes that the web browser cannot directly handle (e.g., “mailto:” and “news:” URIs) are often handed off to another application entirely (e.g., the user's default e-mail application and the user's default newsgroup reader).

In the case of http, https, file, and others, once the resource has been retrieved the web browser will display it. HyperText Markup Language (HTML) code is passed to the browser's layout engine to be transformed from markup to an interactive document. Aside from HTML, web browsers can generally display any kind of content that can be part of a webpage. Most browsers can display images, audio, video, and Extensible Markup Language (XML) files, and often have plug-ins such as Flash applications and Java applets, for example. Upon encountering a file of an unsupported type or a file that is set up to be downloaded rather than displayed, the browser often prompts the user to save the file to disk or identify a program that can open it.

Interactivity in a webpage can also be supplied by JavaScript or other scripting languages such as, but not limited to, Visual Basic Scripting Edition (VBScript), which usually does not require a plug-in. JavaScript can be used along with other technologies to allow “live” interaction with the webpage's server via Ajax. In the most advanced browsers, JavaScript programs can produce interactive 2D graphics using the canvas application programming interface (API) and fully rendered 3D graphics using the Web-based Graphics Library (WebGL).

Information resources may contain hyperlinks to other information resources. Each link contains the URI of a resource to go to. When a link is clicked, the browser navigates to the resource indicated by the link's target URI, and the process of bringing content to the user begins again.

Many organizations would like to upgrade their browser software. For instance, many companies would like to upgrade to Internet Explorer (IE) 8 and MICROSOFT™ Windows® 7, which are currently the most up-to-date release of the MICROSOFT™ browsers. For various reasons, these upgrades are unavailable. For instance, it may be that the companies depend on web applications which were designed for IE 6 and the various changes in layout, rendering, scripting and security designs of IE 8 prohibit those applications from functioning properly without extensive and expensive modifications or upgrades.

Accordingly, the present inventors provide an add-on for browser software such as IE that, depending on embodiment, can allow enterprises and individuals to upgrade to modern technologies, such as Windows® 7, IE 8, IE 9, and their replacements, while maintaining compatibility with existing browser web applications such as IE 6, without changing the underlying code. Incompatibility may result only in the formatting being off leading to a poor presentation, and in extreme circumstances can mean that certain functionality of the website of web application is disabled. Though IE is mentioned, it should be noted that this need exists for all browsers that are periodically updated, such as, but not limited to Mozilla Firefox, GOOGLE™ Chrome, APPLE Safari, and OPERA™.

### SUMMARY OF THE DISCLOSURE

The present disclosure is directed to exemplary methods, exemplary apparatus and exemplary systems that provide browsers with a form of backward compatibility as part of a technical solution that ensures that web application continuity can be assured into the future. Web application continuity provides solutions to manage, maintain and operate web applications regardless of the underlying browser life cycle. While web-based applications may be built to serve businesses for years including websites and enterprise software, the rate of browser innovation has apparently accelerated to the point it outpaces the standard of IT technology system lifecycle.

In an embodiment, a system provides web application continuity by delivering the ability to use and control multiple browser modes, fully customize the browsing environment, and rollback web plug-in support to legacy versions within IE8 or IE9. In this way, an exemplary system can allow organizations to take advantage of the features and better security of the latest platforms and yet migrate their legacy IE6 (or IE7, etc.) applications on their own timeframes and budgets.

Depending on implementation, embodiments discloses herein can decouple the browser/web application dependency as it is understood today. Exemplary embodiments enable individuals and organizations to deploy technologies when appropriate or desirable without necessarily breaking existing lines of business applications or disabling the proper views of web pages developed with predecessor browser technologies. Also dependent upon the exemplary implementations, the present browser add-on for browser software can appear seamless to users insofar as it may be integrated into the browser and more easily managed than using a virtualization solution.

In one, embodiment, a web application compatibility solution (e.g., Browsium Ion™) is controlled by a hierarchical system of profiles and rules, defined using a configuration manager (e.g., the Ion Configuration Manager™). According to this embodiment, the configuration manager provides tools to sidestep compatibility issues by delivering different versions of registry settings or ActiveX controls to the web applications that need them. Through the use of custom ActiveX, File and Registry settings features, an administrator or other user can manage browser extensions that are otherwise incompatible with a particular version or architecture of MICROSOFT™ Windows® or IE. In accordance with this embodiment, the system manages the way a natively installed version of IE renders content and when invoked automatically by a rule or manually controlled using an administration toolbar within a graphical user interface (GUI), the system ensures that web applications load the needed version of an add-on, inject the proper JavaScript code, and carry forward legacy IE environment and security settings—all without modifying the Windows® and IE installations or reducing the security posture of the system. This exemplary embodiment renders legacy web applications and content directly inside a tab in IE8 or IE9, running the application just as it would in a ‘standalone’ version of IE, for example. The system defers ancillary functions like browser settings and file system tasks to the installed version of IE. This approach requires fewer resources than does running a full instance of IE and reduces the attack surface while still loading legacy components. According to this embodiment, the web application compatibility solution acts as a broker between the installed browser and the requested web content and uses software isolation to display content with defined browser engine components and settings on an opt-in basis. In other words, in accordance with this exemplary embodiment, the web application compatibility solution intervenes when—and only when—it is told to.

In another embodiment, a document or webpage is read to determine how to render the document instead of merely relying on header information or a Multipurpose Internet Mail Extensions (MIME) type of the document. According to this embodiment, an optimal viewer or rendering engine for the document is determined using a document type declaration (DOCTYPE) for the document, wherein the DOCTYPE, is an instruction that associates a particular document (for example, a Standard Generalized Markup Language (SGML) or XML webpage) with a Document Type Definition (DTD). In this embodiment, a rendering engine can determine and use a formal definition of a particular version of HTML in a webpage, which is indicated with a DOCTYPE instruction. According to this embodiment, pages can be rendered using an IE7 standard engine and behavior if a webpage or resource contains a DOCTYPE in the first position (i.e., no text preceding the declaration) and that DOCTYPE declaration is anything other than ‘QUIRKS.’ Alternatively, pages can be rendered using a Quirks Mode engine and behavior if the webpage has no DOCTYPE declaration, expressly includes a QUIRKS DOCTYPE declaration, or if the DOCTYPE declaration is not in the first position.

In yet another embodiment, by taking advantage of identifying metadata provided by a document or webpage, a rendering engine can display objects other than web pages. While browsers traditionally support common metadata such as file extensions and MIME types to determine how to load documents, this embodiment goes further by generating further identifiable information through methods such as document analysis not provided in traditional systems and techniques. In accordance with this embodiment, a rendering engine is configured to render objects and files associated with non-browser applications such as, but not limited to, graphics, e-mail, database, word processing, spreadsheet, and other business productivity applications like the suite of MICROSOFT™ Office applications. According to this embodiment, the rendering engine can display objects, data, word processing documents and files such as MICROSOFT™ Word documents, MICROSOFT™ Office Access and SQL Server® database objects, Visio diagrams, Excel spreadsheets and Power Point presentations, and Outlook/Exchange e-mail objects (i.e., mailboxes, messages, calendar events) as they would appear in a previous version of their associated application even though the rendering occurs on a client device with a subsequent, newer version of the application installed. In one embodiment, the identifying metadata provided by a document or webpage can be used to render a document as it would appear in a previous version of its associated application as a ‘viewport’ wherein a user can ‘flip pages’ within a tab of browser application to view renderings of the document as they would appear in prior versions of the document's associated application. According to this embodiment, rendering modes such as Quirks mode together with DOCTYPES, MIME types, and file extensions can be used to relate back to browsers (or other applications such as word processing software) that download content from a URL and display the content a viewport. For example, a Quirks mode can be used by a browser to maintain backward compatibility with web pages designed for older browsers. In this embodiment, rendering modes can be based on inherent and/or derived properties and metadata present within a document or related to the location (i.e., the URL) or delivery stream (e.g., HTTP headers or network packets) of a document.

### BRIEF DESCRIPTION OF THE DRAWING FIGURES

The accompanying drawings, which are incorporated herein and form part of the specification, illustrate exemplary embodiments of the present disclosure and, together with the description, further serve to explain principles, aspects and features of the present disclosure. The exemplary embodiments are best understood from the following detailed description when read in conjunction with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a diagram illustrating the system architecture of a client device running a browser application interconnected with the website, in accordance with an exemplary embodiment of the present disclosure.

FIG. 2 is a graphical illustration of the layers of the display in accordance with an exemplary embodiment of the presently disclosed rendering browser add-on.

FIG. 3 is a detailed architecture diagram of the exemplary browser application shown in FIG. 1.

FIG. 4 illustrates the high level architecture and component relationships for a browser add-on, in accordance with an exemplary embodiment of the present disclosure.

FIG. 5 is a flowchart embodying a method for allowing a browser application running on a client device to access alternative versions of select portions of the browser application, in accordance with an exemplary embodiment of the present disclosure.

FIG. 6 is a flowchart illustrating the logical workflow for a rendering engine, in accordance with an exemplary embodiment of the present disclosure.

FIG. 7 is a flowchart illustrating the logical workflow for an adaptive Quirks rendering engine, in accordance with an exemplary embodiment of the present disclosure.

FIG. 8 is a flowchart illustrating operational steps by which an adaptive Quirks mode of the presently disclosed browser add-on enables a browser application running on a client device to access alternative versions of select portions of the browser application, in accordance with exemplary embodiments of the present disclosure.

FIG. 9 is a flowchart illustrating operational steps by which the presently disclosed browser add-on enables a browser application running on a client device to access alternative versions of select portions of the browser application, in accordance with exemplary embodiments of the present disclosure.

FIGS. 10A and 10B are flowcharts illustrating steps by which settings are loaded for the presently disclosed browser add-on, in accordance with exemplary embodiments of the present disclosure.

FIGS. 11-21 depict a graphical user interface (GUI) for displaying an administrative interface for configuration management of the presently disclosed browser add-on, in accordance with exemplary embodiments of the present disclosure.

FIG. 22 is a diagram of an exemplary computer system in which embodiments of the present disclosure can be implemented.

### DETAILED DESCRIPTION OF THE INVENTION

### Browser Add-on for Enhanced Browser Application Functionality

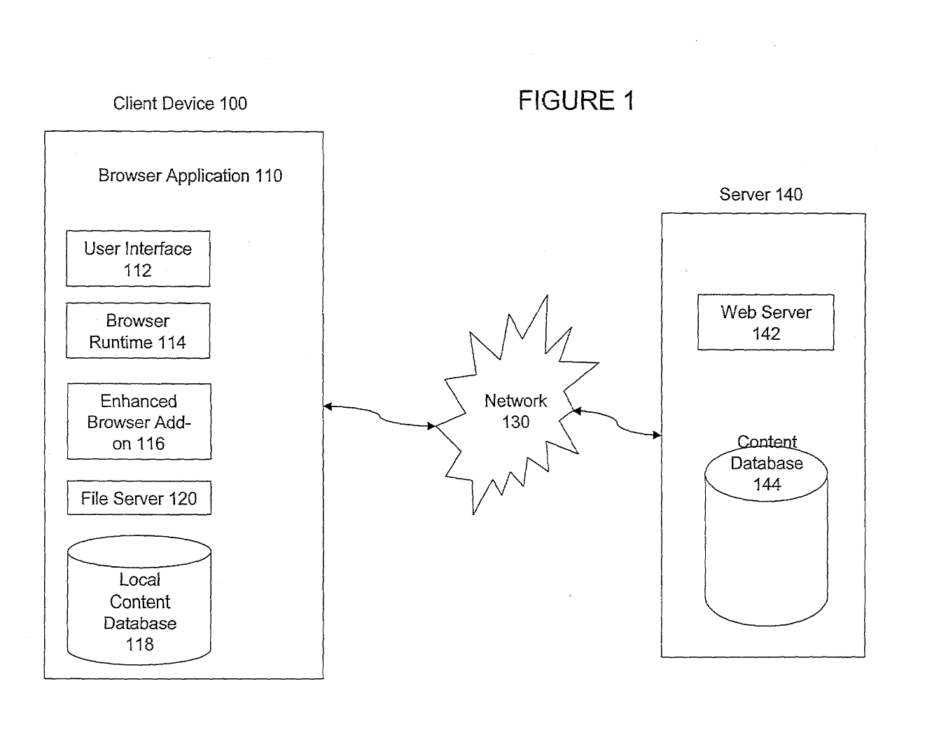

A client device is a computing device that can receive user input and can transmit and receive data via a network. A client devices can include, but is not limited to, a desktop computer, a laptop computer, a netbook computer, a Personal Digital Assistant (PDA), a tablet computing device, an iPhone™, an iPod™, an iPad™, a device operating the Android operating system (OS) from Google Inc., a device running the MICROSOFT™ Windows® Mobile OS, a device running the MICROSOFT™ Windows® Phone OS, a device running the Symbian OS, a device running the webOS from Hewlett Packard, Inc., a mobile phone, a BlackBerry® device, a smartphone, a hand held computer, a palmtop computer, an ultra-mobile PC, or nearly any other device having computing functionality and data communication capabilities. As illustrated in FIG. 1, the client device 100 communicates via a network 130. The network 130 is to be broadly construed to include any combination of local area and/or wide area networks using both wired and wireless communications. Additionally, the browser application 110 of the client device 100 can be used for accessing local content database 118 through a file server 120, for instance.

Unless specifically stated differently, in an embodiment, a user and administrator are interchangeably used herein to identify a human user, a software agent, or a group of users and/or software agents. Besides a human user or system administrator who may need to run and configure web applications using a browser, a software application or agent sometimes need to invoke, run, and configure web applications. Accordingly, unless specifically stated, the terms “user” and “administrator” as used herein do not necessarily pertain to a human being.

When the client device 100 communicates over the network 130, it generally communicates with web servers linked to a website hosted by a server. As illustrated, a web server 142 of a server 140 on a network 130 is in communication with a content database 144. Only one is shown, but of course it is contemplated there could be many more. The web server 142 serves web pages as well as other web-related content such as Java, ADOBE™ Flash, XML and any other protocol or software that is implemented for use in conjunction with the browser application 110, whether or not over a network 130. It is to be understood that the browser application 110 depicted in FIG. 1 is not limited to a design wherein the browser application 110 is running within an Internet browser such as IE. For example, in an embodiment, the browser application 110 can be a first application (i.e., ‘application A’) that utilizes another, second application (i.e., ‘application B’) that interprets network communication, whereas application B will most commonly be a web browser.

The browser application 110 allows the user to retrieve and present information available in resources via the Internet or on a private network put through a file server and file server locally. By locally, it is meant that the same computing device (with one or more processors) within a client device 100 with or without peripheral devices connected thereto. The web server 142 might send documents in a mark-up language such as html or xml through the use of a uniform resource locator (URL) and identifies the location of the resource such as a webpage, a media file, (e.g. image or video) or any other piece of content that might be hosted by a server.

The browser application 110 has a user interface 112 representing information of the user as well as allowing the user to provide input, such as data or requests from the user that might be sent to the server 140 or the file server 120. The reply may be a mark up language document comprising information and instructions for rendering an image provided and for taking actions on the client device 100. The browser runtime 114 processes a mark up language document and renders for display on a user interface and takes actions based on instructions provided in the mark up language document. In some embodiments, the browser runtime 130 can include a scripting engine for processing instructions provided on a client side scripting engine.

The browser runtime 130 also allows access to a local storage or data store, such as local content database 118, either directly or through a file server 120. Local run time data stored in local content database 118 might include text documents, images, video files or other multimedia files while on the client device 100.

The browser application 110 also includes an enhanced browser add-on 116, which is a focus of the present disclosure.

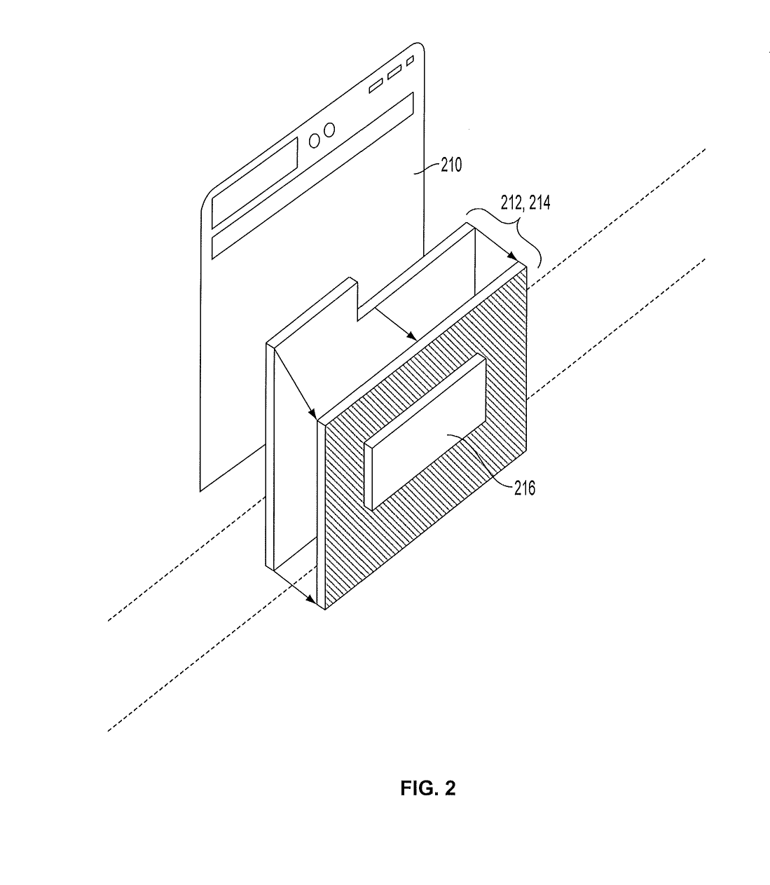

To illustrate the effect of the enhanced browser add-on 116, FIG. 2 illustrates the conventional browser frame 210, such as an IE frame. The enhanced browser add-on 116 can be in the form of a browser helper object (BHO), which is a DLL module designed as a plug-in for the MICROSOFT™ IE web browser to provide an added functionality. BHOs are loaded once by each new instance of the IE but can be launched for each window. Other examples of BHOs include ADOBE™ ACROBAT™ which allows IE users to read Portable Document Format (PDF) files in their browser.

As illustrated in FIG. 2, an IE tab 212 overlays the IE frame 210. Earlier versions of IE did not include tabs, so if a website or a browser-based application was built with an earlier version of IE, namely IE 6 for instance, the tabs would not be supported, leading to potential formatting and/or display errors. Additionally, the present enhanced browser add-on 116 renders a window 214 that overlays the IE tab as well as a provider 216, which represent an IE 6 overlay, for instance, in this example. For web browsers that do not have a tab interface, the tab 212 can be physically and functionally merged with the frame 210. For example, in an embodiment, for a browser or application being targeted that does not support tabs, “tab 212” is implemented as a “viewport.”

As would be apparent to one skilled in the relevant art(s), the provider 216 overlay masks any difficulty that the modern IE version would have in rendering of page that was built for a prior version of the browser insofar as that overlay is provided by a rendering engine of the earlier browser and overlaid on the display rendered by the current browser.

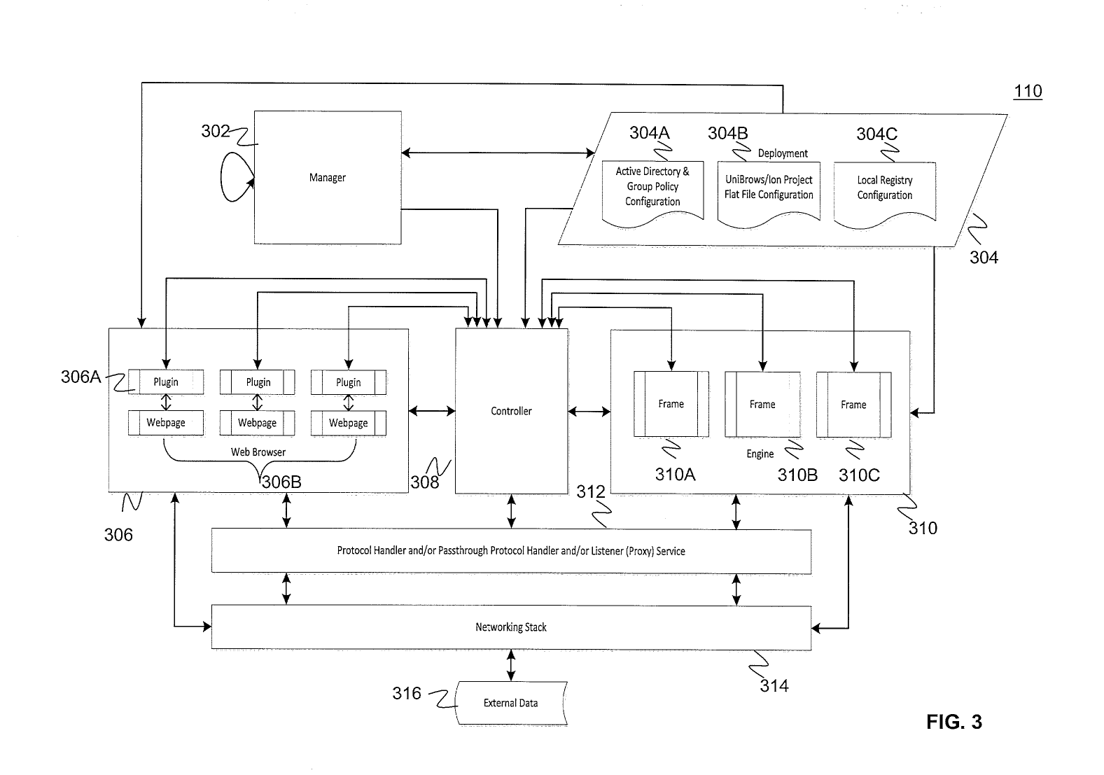

FIG. 3 illustrates an exemplary embodiment of details of the browser application 110. It includes a manager 302 that has server and administration components. The manager 302 provides for administration and is used to define rules, profiles and settings used by clients. Rules, profiles and settings might include designating certain web-based applications or websites as being suitable for rendering using an earlier version of the rendering engine. Alternatively, in instances where the earlier browser version has code elements that differentiate it from the current version, the rules, profiles and settings can include detecting the presence of those distinguished code elements, the response to which is the selection of the correct or optimal rendering engine, or at least an engine that will render the resource as closely as it was intended to be rendered. The manager 302 runs only when needed in certain exemplary embodiments. The manager 302 pushes settings out via choice of deployment technology which can be set by the client or by the provider of the software.

The manager 302 is loosely connected to a deployment module 304. The deployment module 304 uses AD/GP, local registry settings or flat file format. That is, it has an active directory and group policy configuration in 304A, an enhanced browser plug-in project flat file configuration 302B, and a local registry configuration 304C. The manager 302 controls the deployment 304 and they in turn work at communicating in conjunction with the client components 306, 310, 312 and 314. In this instance, the web browser 306 includes a plurality of plug-ins 306A (e.g., one for IE 6, which is externally accessed or downloaded into the browser), which help render web pages 306B. The web browser 306 is controlled and communicates with both the controller 308 and the deployment 304 in order to render images on a display screen.

A controller 308 implements a broker process and always runs in the background of each client machine in this exemplary embodiment. It stores administration-set rules, profiles and settings. The controller 308 also communicates with the rendering engine 310 to form individual frames 310A, 310B, and 310C to respond to the enhanced browser plug-in when required. The controller 308 also communicates with the web browser 306, and, in the exemplary embodiment depicted in FIG. 3, plug-in 306A.

Additionally, the engine 310 renders frames 310A, 310B, and 310C either in accordance with the browser application without a plug-in, or with the enhanced browser plug-in 316 as controlled by the controller 308 and the deployment 304. The engine 310 incorporates a copy of the enhanced browser plug-in that runs a profile. This engine is named after the version of the application it is targeting. For instance, it might be named Browsium.Continuity.Firefox.exe or Browsium.Continutiy.Chrome.exe, wherein Continuity™ refers to the backend of Ion™, a commercial name of a commercial product of one of the disclosed enhanced browser plug-ins, and where ‘InternetExplorer’ stands for MICROSOFT™ Internet Explorer, Firefox stands for MOZILLA Firefox, and Chrome stands for GOOGLE™ Chrome. For example, an engine 310 for IE and the copy of the enhanced browser plug-in is Browsium.Continuity.InternetExplorer.exe and Browsium.Continuity.InternetExplorer.Dep.exe. These naming conventions could be used for other applications outside of web browsers, where the name of the targeted application may be shortened and used in the executable name of an engine or profile executable in order to better associate the engine or profile executable with its targeted application.

The browser application 110 may include a protocol handler and/or pass-through protocol handler 312 (e.g., WinInet.dll in IE) and/or a proxy server and/or a reverse proxy server and/or any other mechanism allowing the browser application to intercept and alter communication flowing to and from a targeted application. for HTTP, HTTPS and FTP. It handles all network communication over these protocols and communicates with the web browser 306 and the rendering engine 310 (e.g., Trident in IE, Gecko in Firefox, or WebKit in Chrome and Safari), as well as a network stack 314. The network stack 314 is a protocol stack (sometimes communications stack), which is a particular software implementation of a computer networking protocol suite defining the protocols, and the stack is the software implementation of them. Individual protocols within a suite are often designed with a single purpose in mind. This modularization makes design and evaluation easier. Because each protocol module usually communicates with two others, they are commonly imagined as layers in a stack of protocols. The lowest protocol always deals with “low-level”, physical interaction of the hardware. Every higher layer adds more features. User applications usually deal only with the topmost layers (see, e.g., the Open Systems Interconnection (OSI) model). In practical implementation, protocol stacks are often divided into three major sections: media, transport, and applications. A particular operating system or platform will often have two well-defined software interfaces: one between the media and transport layers, and one between the transport layers and applications. For example, the media-to-transport interface would define how TCP/IP transport software would talk to Ethernet hardware, to receive external data 316. Examples of these interfaces include Open Data-Link Interface (ODI) and Network Driver Interface Specification (NDIS) in the MICROSOFT™ Windows® and DOS environment.

In an embodiment, the engine 310 and/or the plug-in 306A communicates with the controller 308 to determine when to run. The engine 310 and/or the plug-in 306A responds to the correct browser engine and settings (e.g., profiles) within the browser tab.

According to an embodiment, when a user requests a page that matches a rule, the engine 310 displays the content using an alternate browser engine specified by that rule. Browser engines that can be specified by a rule, include, but are not limited to, IE Quirks, Adaptive IE Quirks (a combination of IE Quirks and IE7 Standards), Emulate IE7, Emulate IE8, Emulate IE9, IE7 Standards, IE8 Standards, IE9 Standards, and IE Edge.

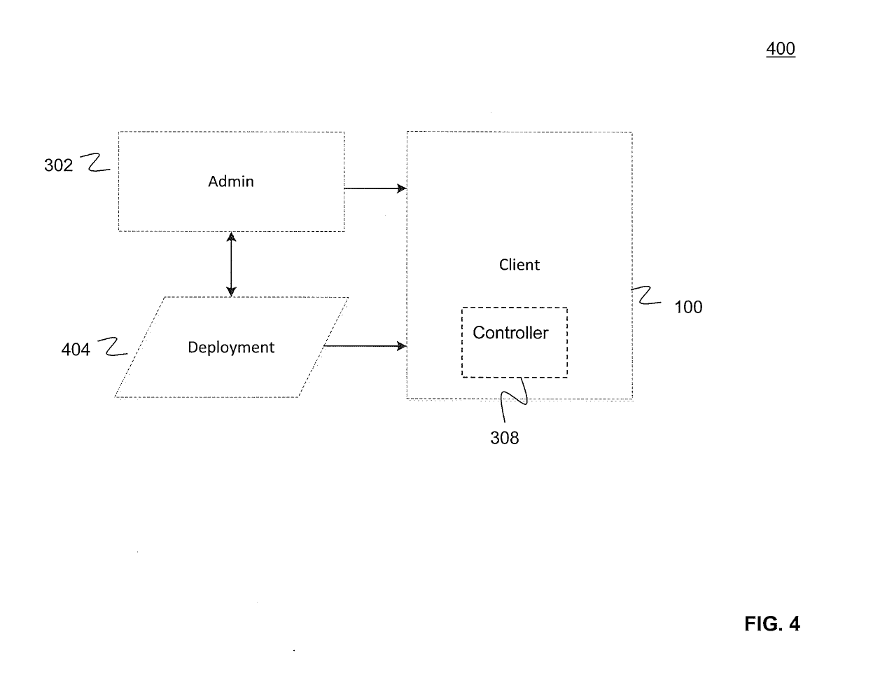

FIG. 4 depicts the browser architecture 400 in its hierarchal form. FIG. 4 is described with continued reference to the embodiments illustrated in FIGS. 1 and 3. However, FIG. 4 is not limited to those embodiments.

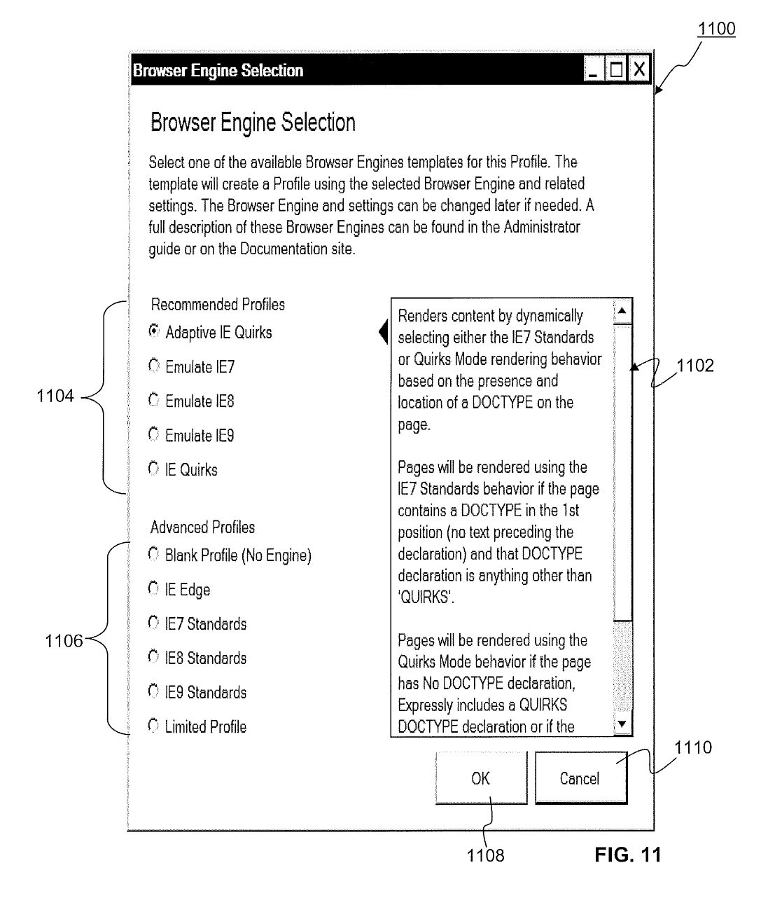

As shown in FIG. 4, browser architecture 400 includes administrative and management components 302, which communicate with client device 100. Example user interfaces for the administrative and management components 302 are described below with reference to FIGS. 11-21. As shown in FIG. 4, browser architecture 400 includes a controller 308 hosted by the client device 100. Browser architecture 400 further comprises a deployment module 404, that performs bidirectional communication with the administrative and management components 302 as the enhanced browser add-on 116 for browser application 110 is configured (i.e., by a user or administrator). Based on the information received from the administrative and management components 302, the deployment module 404, communicates with the client device 100 to convey data, such as, but not limited to, a selected rendering engine 310, rules, local settings, and a local group policy, to the client device 100.

### Method Embodiments

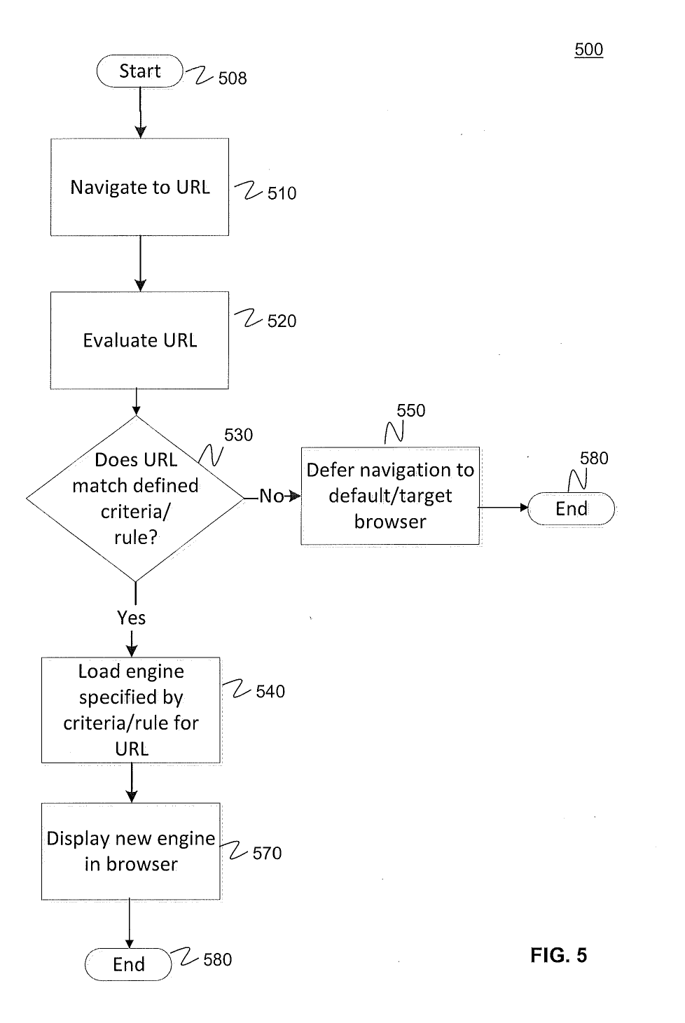

FIG. 5 is a flowchart embodying a method for allowing a browser application running on a client device to access alternative versions of select portions of the browser application.

FIG. 5 is described with continued reference to the embodiments illustrated in FIGS. 1-4. However, FIG. 5 is not limited to those embodiments. As can be seen in FIG. 5, the disclosed system includes a computer implemented method 500 for using an enhanced browser add-on 116 to enable a browser application 110 running on a client device 100 to access alternative versions of select portions of the browser application.

Method 500 begins in step 508 and proceeds to step 510 when a user navigation to a URL (either local or external content) is intercepted. This navigation could occur on any browser or web client that the Ion or UniBrows products, or other embodiments disclosed herein are configured to monitor and intercept navigations from to a resource by a uniform resource locator (URL) and intercepting navigation to the resource located by the URL.

In step 520, properties of the resource located by the URL are evaluated against user- or computer-generated criteria or rules to determine whether an enhanced browser module is to continue processing the URL request or allow the URL request to proceed as it normally would without using the enhanced browser module. Properties of the URL represent a number of identifiable markers corresponding to the resource or address of that resource. For instance, these properties can be related to the string representation of the URL (or parts thereof); they may be related to headers, server codes, or other information related to the transfer of the resource identified by the URL; they may be related to the contents of the resource identified by the URL; or they may be related to any number of other factors, metadata, content, etc. pertaining to the URL, the resource itself, the communication of said resource, or the loading of said resource. After the evaluation is complete, control is passed to step 530.

In step 530 a determination is made to determine if the resource located by the URL matches a defined criteria/rule. If there is a match based on the criteria and search parameters discussed above with reference to step 520, the enhanced browser module continues with navigation of the URL from a default browser and control is passed to step 540. If the resource located by the URL does not match defined criteria or rule, control is passed to step 550.

In step 550, the enhanced browser module ceases operation within the navigation and relinquishes control of that navigation to the default browser originally handling the URL request and control is passed to step 580 where the method ends.

In step 540, the method 500 loads the rendering engine 310 specified by the criteria/rule and passes control to step 570.

In step 570, information received from the resource located by the URL is processed in order to display the content for that URL in a custom engine within the user interface (UI) constructs of the default or target browser using the appropriate engine as specified by the rules, profiles and settings. The resource can be either local or external. After this processing, control is passed to step 580 where the method ends.

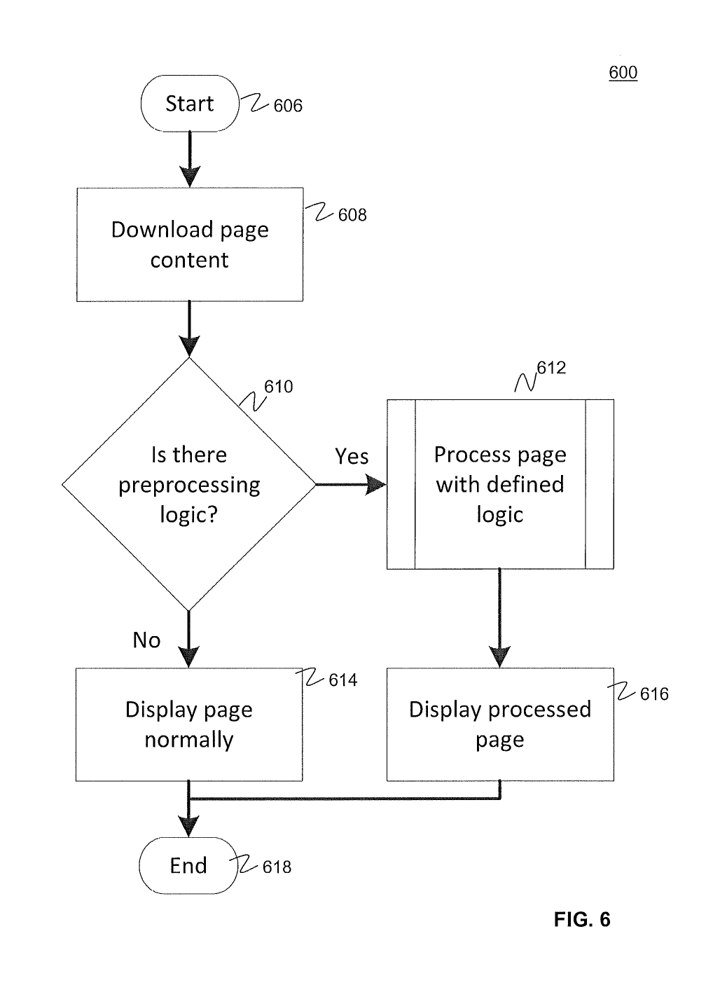

FIG. 6 is a flowchart illustrating the logical workflow for an embodiment of the rendering engine 310. In particular, FIG. 6 illustrates a flowchart 600 for downloading, inspecting, and rendering a document.

Flowchart 600 can use an extension, MIME type, raw file header, portions of or all of the document contents, document properties, derived properties, document metadata, derived metadata, or other identifiable markers for a document to render a document as it would appear in a previous version of its associated application as a ‘viewport’ wherein a user can ‘flip pages’ within a tab of browser application 110 to view renderings of the document. Documents or files that do not base themselves off of SGML (and even some that do) may not have a DOCTYPE, thus the DOCTYPE cannot be used in those situations and the above-noted properties, metadata, and markers can be used instead.

Flowchart 600 begins in step 606 and proceeds to step 608 where page content for a webpage is downloaded. After the webpage content is downloaded, control is passed to step 610.

In step 610, a determination is made as to whether there is preprocessing logic for the page content downloaded in step 606. If it is determined that there is preprocessing logic for the page content, control is passed to step 612. If it is determined that there is not preprocessing logic for the page content, control is passed to step 614.

In step 612, the webpage is processed in accordance with the defined, preprocessing logic determined in step 610. After the page is processed, control is passed to step 616 where the processed page is displayed. After the page is displayed, control is passed to step 618 where the flowchart 600 ends.

In step 614, in response to determining that there is not preprocessing logic for the page content, the page content downloaded in step 610 is displayed normally and control is passed to step 618 where the flowchart 600 ends.

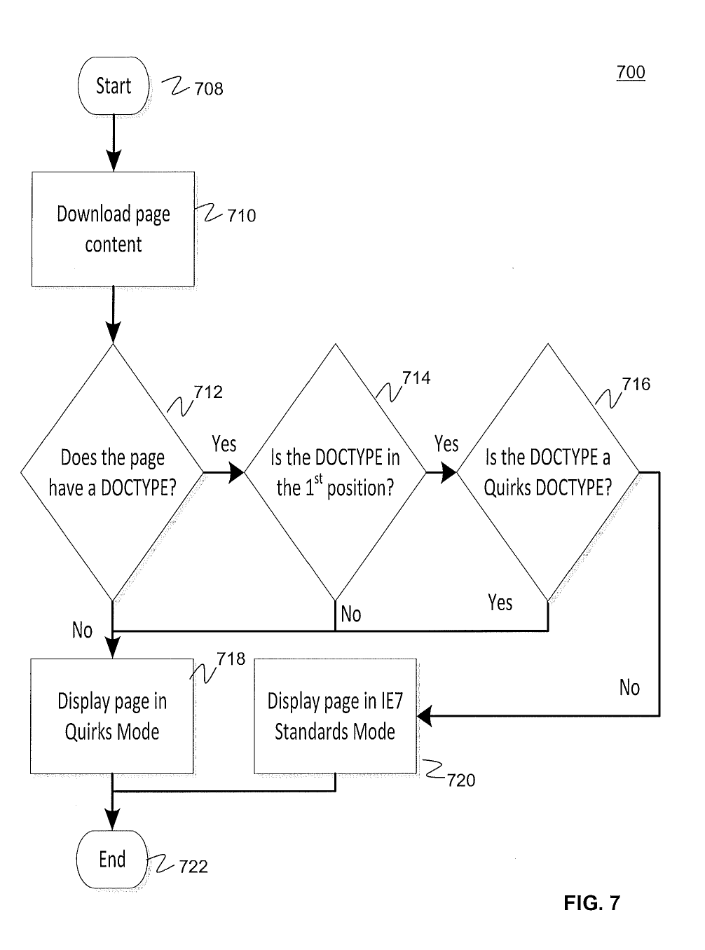

FIG. 7 is a flowchart illustrating a logical workflow for an adaptive Quirks rendering engine. In particular, the logical workflow 700 illustrated in FIG. 7 depicts the steps for rendering content by dynamically selecting either the IE7 Standards or Quirks Mode rendering behavior based on the presence and location of a DOCTYPE on in the content of a downloaded webpage. FIG. 7 is described with continued reference to the embodiments illustrated in FIGS. 1-6. However, FIG. 7 is not limited to those embodiments.

As will be appreciated by persons skilled in the relevant art, a document type declaration, or DOCTYPE, is an instruction that associates a particular SGML or XML document (for example, a webpage) with a Document Type Definition (DTD). For example, the formal definition of a particular version of HTML can be indicated with a DOCTYPE instruction. In a serialized form of a document, a DOCTYPE can be implemented as a short string of markup that conforms to a particular syntax. An HTML layout engine in web browsers, such as the browser application 110, can perform DOCTYPE detection through parsing, ‘sniffing’ or ‘switching’, wherein the DOCTYPE in a webpage or document served as text or HTML determines a layout mode, such as, but not limited to, a ‘Quirks mode’ or a ‘standards mode.’ The text/HTML serialization of HTML5, which is not SGML-based, uses the DOCTYPE for mode selection. As web browsers, such as browser runtime 114 can be implemented with special-purpose HTML parsers, rather than general-purpose DTD-based parsers, they do not use DTDs and will not access them even if a URL is provided. Thus, the DOCTYPE is retained in HTML5 as a header only to trigger ‘standards mode’ in browsers such as browser runtime 114.

In the exemplary embodiment shown in FIG. 7, pages will be rendered using the IE7 Standards behavior if the page contains a DOCTYPE in the first position (i.e., no text preceding the declaration) and that DOCTYPE declaration is anything other than ‘QUIRKS’. Alternatively, pages will be rendered using the Quirks mode behavior if the page has no DOCTYPE declaration, expressly includes a QUIRKS DOCTYPE declaration, or if the DOCTYPE declaration is not in the first position. For example, FIG. 7 and workflow items 700-799 are specific to using a DOCTYPE in order to render a SGML-based page in a certain engine.

By taking advantage of a document's inherent or derived properties and metadata, embodiments of the invention can be used to render objects other than web pages. Workflow 700 can be adapted using alternative forms of metadata and properties that bear functional similarity to that of DOCTYPEs. For example, workflow 700 can be adapted to be used to render objects and files associated with non-browser applications such as, but not limited to, business productivity applications like the suite of MICROSOFT™ Office applications. In this way, workflow 700 can be used in conjunction with rendering engine 310 to render objects, data, word processing documents and files such as MICROSOFT™ Word documents, Excel spreadsheets and Power Point presentations, and Outlook/Exchange e-mail objects (i.e., mailboxes, messages, calendar events) as they would appear in a previous version of an associated application even though a user's client device 100 has a current version of the application installed on it. Although the exemplary embodiment of FIG. 7 indicates that a DOCTYPE is used, in other embodiments, as described above with reference to FIG. 6, workflow 700 can also use an extension, MIME type, raw file header, portions of or all of the document contents, document properties, derived properties, document metadata, derived metadata, or other identifiable markers for a document to render a document as it would appear in a previous version of its associated application as a ‘viewport’ wherein a user can ‘flip pages’ within a tab of browser application 110 to view renderings of the document. Thus, workflow 700 can be adapted to handle documents or files that do not have a DOCTYPE by using the above-noted properties, metadata, and markers instead.

Workflow 700 begins at step 708 and proceeds to step 710 where page content for a webpage is downloaded. After the webpage content is downloaded, control is passed to step 712.

In step 712, a determination is made as to whether there is a document type (DOCTYPE) indicated in the page content downloaded in step 710. If it is determined that there is a DOCTYPE for the page, control is passed to step 714. If it is determined that there is not a DOCTYPE for the page content, control is passed to step 718, where the page is displayed by rendering engine 310 in Quirks mode.

In step 714, a determination is made as to whether the DOCTYPE indicated in the page content downloaded in step 710 occurs in the first position of the page. If it is determined that the DOCTYPE occurs in the first position of the page, control is passed to step 716. If it is determined that the DOCTYPE does not occur in the first position of the page, control is passed to step 718, where the page is displayed by rendering engine 310 in Quirks mode.

In step 716, a determination is made as to whether the DOCTYPE in the first position of the page downloaded in step 710 indicates that the page is a Quirks document type. If it is determined that the DOCTYPE indicates that the page is a Quirks document type, control is passed to step 718, where the page is displayed by rendering engine 310 in Quirks mode. If it is determined that the DOCTYPE does not indicate that the page is a Quirks document, control is passed to step 720, where the page is displayed by rendering engine 310 in IE 7 standards mode.

After the page is displayed in either Quirks mode in step 718, or in IE 7 standards mode in step 720, control is passed to step 722 where workflow 700 ends.

It is to be understood that while FIG. 7 and the description of the steps of workflow 700, refers to a specific case of using an SGML-based document and inspecting a document's DOCTYPE, other embodiments of workflow 700 could be created consistent with the description of flowchart 600 described above with reference to FIG. 6.

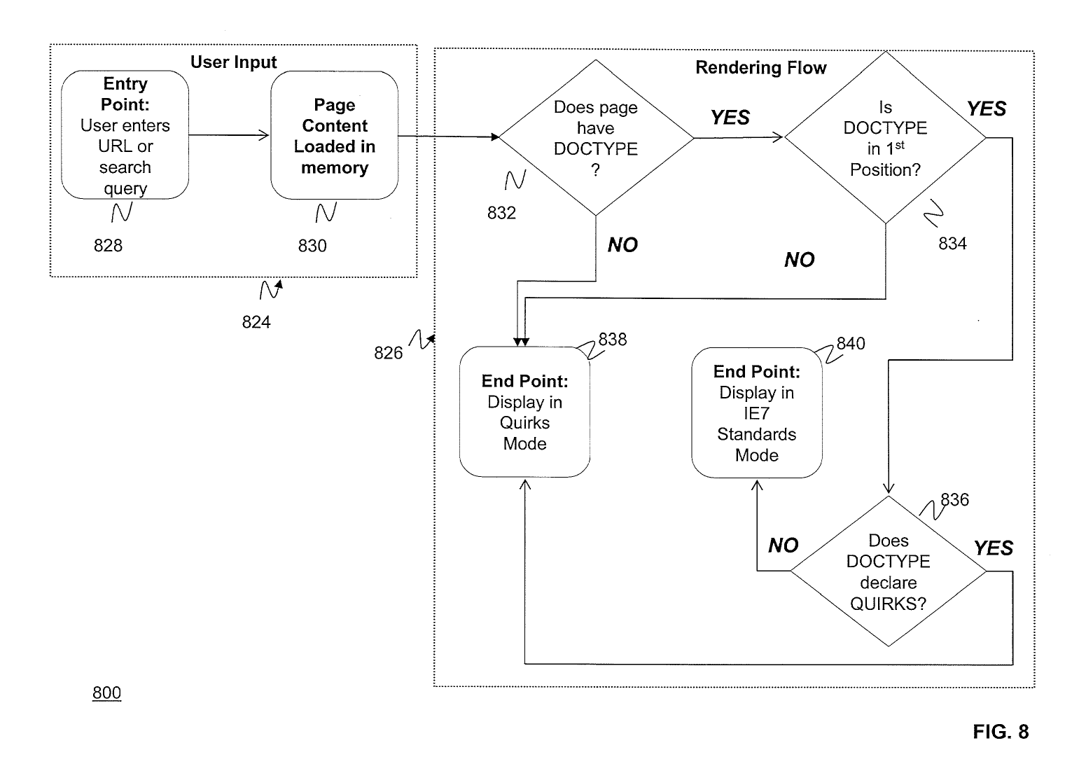

FIG. 8 is a flowchart 800 illustrating operational steps by which an adaptive Quirks mode of the presently disclosed browser add-on 116 enables a browser application running on a client device to access alternative versions of select portions of the browser application.

FIG. 8 is described with continued reference to the embodiments illustrated in FIGS. 1-7. However, FIG. 8 is not limited to those embodiments.

As shown in FIG. 8, the steps of flowchart 800 are performed in response to a user input 824, which triggers the illustrated rendering flow 826.

The Entry Point of flowchart 800 is in step 828 where a user enters a URL or search query in a user interface 112 of a client device 100. After the URL or search query is received, control is passed to step 830 where the page content for the requested URL or search is loaded into memory of the client device 100. After the page content is loaded into memory, control is passed to step 832, where the rendering flow 826 begins.

In step 832, a determination is made as to whether there is a DOCTYPE instruction in the page loaded into memory in step 830. If it is determined that there is a DOCTYPE in the page, control is passed to step 834. If it is determined that there is not a DOCTYPE in the page, control is passed to end point 838 where the page is displayed by rendering engine 310 in Quirks mode.

In step 834, a determination is made as to whether the DOCTYPE indicated in the page loaded into memory in step 830 occurs in the first position of the page. If it is determined that the DOCTYPE occurs in the first position of the page, control is passed to step 836. If it is determined that the DOCTYPE does not occur in the first position of the page, control is passed to step 838, where the page is displayed by rendering engine 310 in Quirks mode.

In step 836, a determination is made as to whether the DOCTYPE in the first position of the page loaded into memory in step 830 indicates that the page is a Quirks document type. If it is determined that the DOCTYPE indicates that the page is a Quirks document type, control is passed to end point 838, where the page is displayed by rendering engine 310 in Quirks mode. If it is determined that the DOCTYPE does not indicate that the page is a Quirks document, control is passed to end point 840, where the page is displayed by rendering engine 310 in IE 7 standards mode.

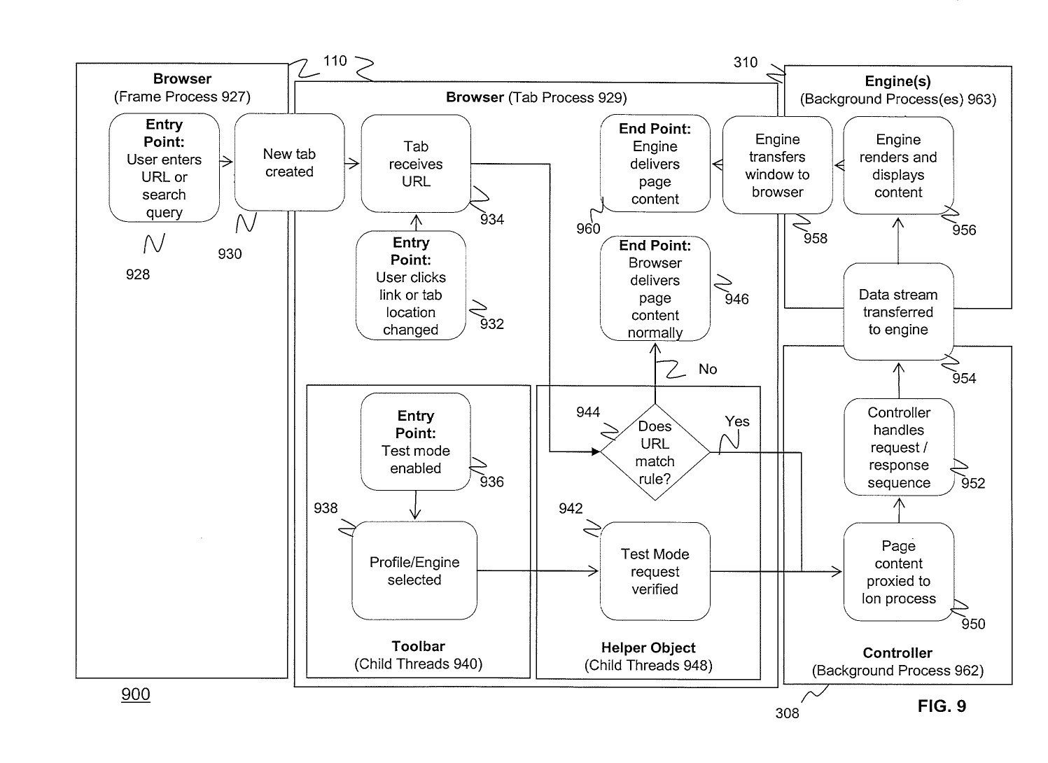

FIG. 9 is a flowchart 900 illustrating operational steps by which the presently disclosed browser add-on 116 enables a browser application running on a client device to access alternative versions of select portions of the browser application.

FIG. 9 is described with continued reference to the embodiments illustrated in FIGS. 1-8. However, FIG. 9 is not limited to those embodiments.

Throughout FIG. 9, the steps of the flowchart 900 are depicted as being within or contained by components of client device 100 that carry out the steps. Steps that are accomplished by more than one component are depicted in FIG. 9 as overlapping the boundaries of multiple components (i.e., to illustrate that two components work in conjunction with each other to perform a given step). While FIG. 9 describes process separation (see, e.g., the descriptions of steps 927, 929, 940, 948, 963, 962 below), the process separation provided is an example of the one used by the exemplary embodiment of FIG. 9 and may differ based on the architecture(s) of other embodiments disclosed herein.

The Entry Point of flowchart 900 is in step 928 where a user enters a URL or search query in a user interface 112 of a client device 100 or a URL or search query is passed into the application via another means. As shown in FIG. 9, step 928 is carried out by a frame process 927 of a browser application 110. After the URL or search query is received, control is passed to step 930 where a new tab is created for the requested URL or search. After the tab, or viewport if the browser/viewing application does not use tabs, is created, control is passed to step 934, where a tab process 926 or process containing the viewport of the browser application 110 receives the URL.

As shown in FIG. 9, another entry point 932 occurs within a tab process 926 of the browser application 110 if a user clicks on a hyperlink or a tab/viewport location is changed, thus causing the tab/viewport process 926 of the browser application 110 to receive the corresponding URL in step 934. After the tab/viewport receives the URL in step 934, control is passed to step 944.

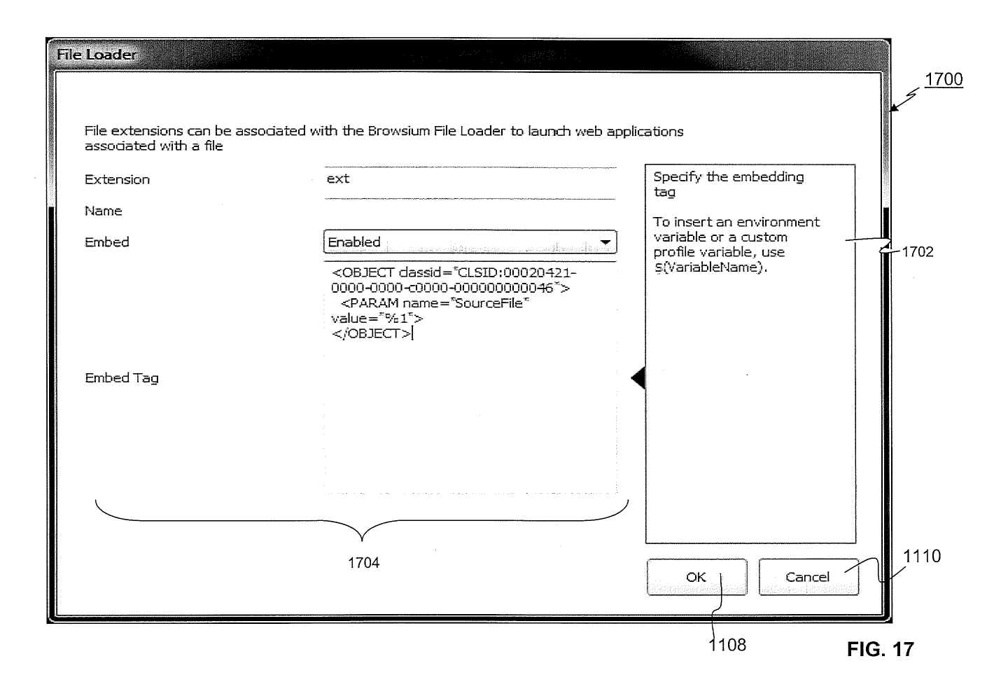

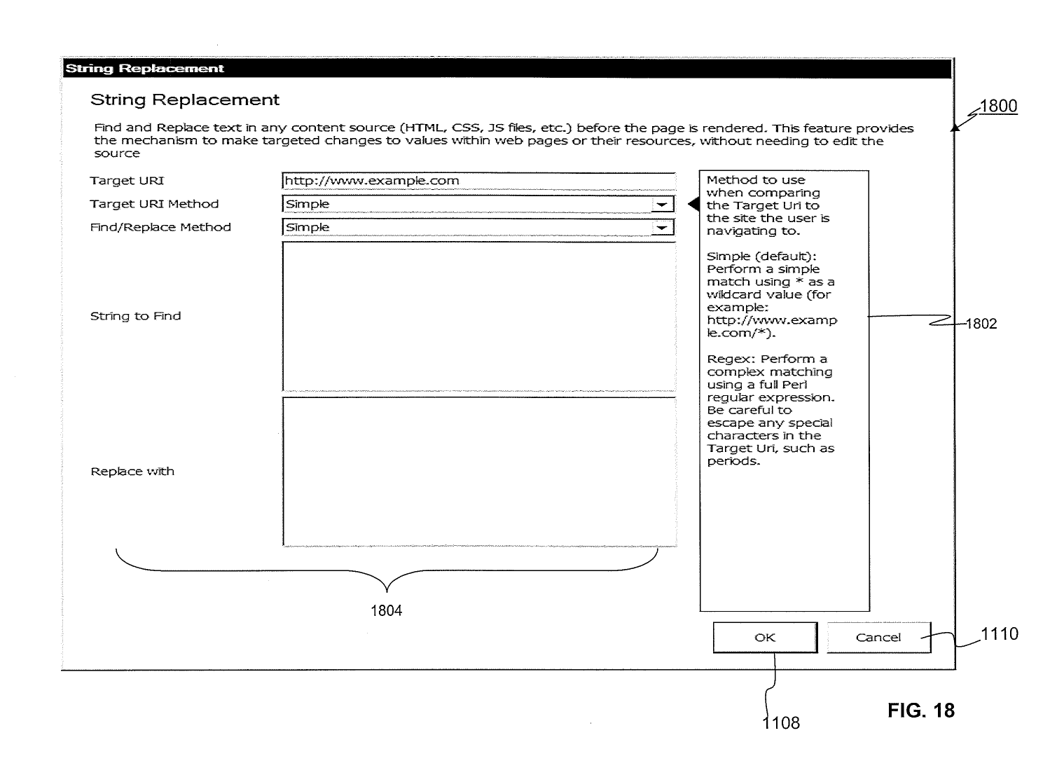

In step 944, a determination is made as to whether the received URL matches a rule. In an embodiment, step 944 determines whether the URL matches one of a plurality of administrator- or user-defined rules created and maintained via an administrative graphical user interface (GUI). Exemplary administrative GUIs 1700 and 1800 for rule creation and modification, respectively, are described below with reference to FIGS. 17 and 18. If it is determined that the URL matches a rule, control is passed to step 950, where controller 308 with background process 962 proxies the page content to a browser add-on 116 process. In the non-limiting embodiment shown in FIG. 9, the page content is proxied to an Ion process in step 950. If it is determined that the URL does not match a rule, control is passed to end point 946 where browser application 110 delivers the page content normally. As illustrated in the exemplary embodiment of FIG. 9, step 944 can be carried out by a helper object or browser plug-in with child threads 948.

After the content is proxied to the browser add-on 116 process, control is passed to step 952 where the controller 308 handles the request/response sequence before passing control to step 954.

In step 954, a data stream is transferred from controller 308 to rendering engine 310. After the data stream is transferred, control is passed to step 956 where rendering engine 310 renders and displays the content corresponding to the URL. As shown in FIG. 9, step 956 can be carried out by rendering engine 310 with one or more background processes 963 running.

After the content is rendered and displayed, control is passed to end point 958 where rendering engine 310 transfers a window to the browser application 110.

After the window is transferred to the browser application 110, end point 960 is reached where rendering engine 310 delivers the page content to the browser application 110.

With continued reference to FIG. 9, another entry point 936 can occur when a test mode is enabled using a toolbar within the browser application 110. After the test mode is enabled, control is passed to step 938. As shown in FIG. 9, steps 936 and 938 can be carried using a toolbar having child threads 940.

In step 938, a profile or rendering engine 310 is selected for the test mode. A non-limiting, exemplary GUI for making this selection is described below with reference to FIG. 11.

After the profile or rendering engine 310 is selected, control is passed to step 942 where the helper object verifies the test mode request. After the test mode request has been verified, control is passed to step 950, and the flowchart 900 steps are performed as described above.

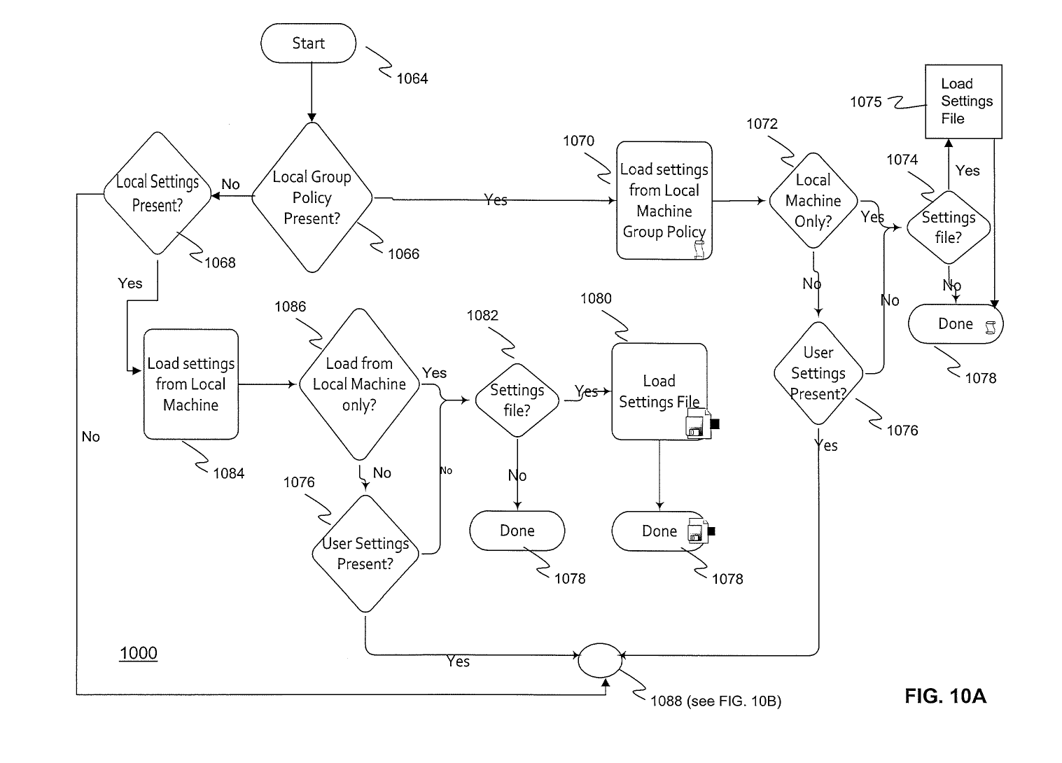

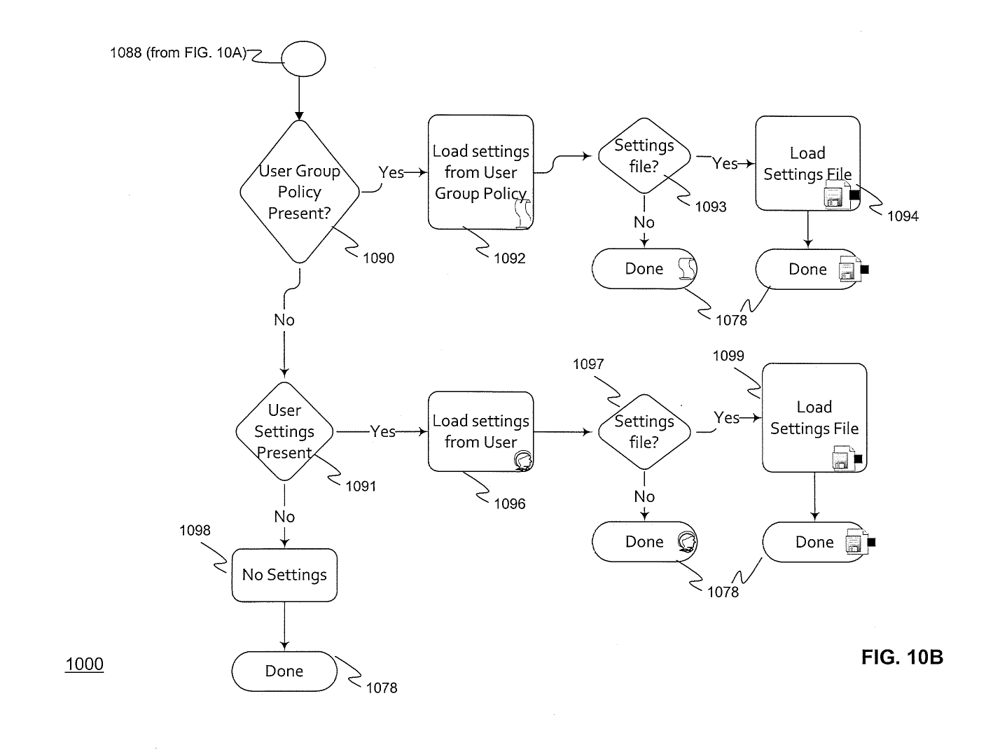

FIGS. 10A and 10B are flowcharts illustrating steps by which settings are loaded for the presently disclosed browser add-on.

FIGS. 10A and 10B are described with continued reference to the embodiments illustrated in FIGS. 1-9. However, FIGS. 10A and 10B are not limited to those embodiments.

With reference to FIG. 10A, a method 1000 for loading settings for the browser add-on 116 begins in step 1064 and proceeds to step 1066 where a determination is made as to whether a local group policy is present. If it is determined that a local group policy is present, control is passed to step 1070, where settings are loaded from a local machine group policy. If it is determined that no local group policy is present, control is passed to step 1068.

In step 1068, a determination is made as to whether local settings are present. If it is determined that local settings are present, control is passed to step 1084, where the local settings are loaded from a local machine. If it is determined that no local settings are present, control is passed to step 1088.

After the settings are loaded from a local machine group policy in step 1070, control is passed to step 1072 where a determination is made as to whether the settings are for a local machine only. If it is determined that the settings are only for the local machine, control is passed to step 1074. If it is determined that the settings are not only for the local machine, control is passed to step 1076.

In step 1074, a determination is made as to whether a settings file exists. If it is determined that a settings file exists, control is passed to step 1075, where the settings file is loaded. If it is determined that no settings file exists, control is passed to step 1078, where the method 1000 terminates.

After the settings file is loaded in step 1075, control is passed to step 1078, where the method 1000 completes.

After the local settings are loaded from the local machine in step 1084, control is passed to step 1086 where a determination is made as to whether the local settings should only be loaded from the local machine. If it is determined that the local settings should only be loaded from the local machine, control is passed to step 1082. If it is determined that the local settings should not be loaded from the local machine exclusively, control is passed to step 1076.

In step 1076 a determination is made as to whether user settings are present. If it is determined that user settings are present, control is passed to step 1088. If it is determined that user settings are not present, control is passed to step 1082.

In step 1082, a determination is made as to whether a settings file exists. If it is determined that a settings file exists, control is passed to step 1080, where the settings file is loaded. If it is determined that no settings file exists, control is passed to step 1078, where the method 1000 terminates.

After the settings file is loaded in step 1080, control is passed to step 1078, where the method 1000 completes.

With reference to FIG. 10B, from step 1088, the method 1000 proceeds to step 1090 where a determination is made as to whether a user group policy is present. If it is determined that a user group policy is present, control is passed to step 1092, where settings are loaded from the user group policy. If it is determined that no user group policy is present, control is passed to step 1091.

In step 1091, a determination is made as to whether user settings are present. If it is determined that user settings are present, control is passed to step 1096, where the user settings are loaded. If it is determined that user settings are not present, control is passed to step 1098.

In step 1098, no settings are loaded and control is passed to step 1078 where the method 1000 terminates.

In step 1098, no settings are loaded and control is passed to step 1078 where the method 1000 terminates.

After settings are loaded from the user group policy in step 1092, control is passed to step 1093, where a determination is made as to whether a settings file exists. If it is determined that a settings file exists, control is passed to step 1094, where the settings file is loaded. If it is determined that no settings file exists, control is passed to step 1078, where the method 1000 terminates.

After the settings file is loaded in step 1094, control is passed to step 1078, where the method 1000 completes.

After the user settings are loaded in step 1096, control is passed to step 1097 where a determination is made as to whether a settings file exists. If it is determined that a settings file exists, control is passed to step 1099, where the settings file is loaded. If it is determined that no settings file exists, control is passed to step 1078, where the method 1000 terminates.

After the settings file is loaded in step 1099, control is passed to step 1078, where the method 1000 completes.

### Example Graphical User Interface

FIGS. 11-21 depict an example graphical user interface (GUIs) for configuration management of the presently disclosed browser add-on. FIGS. 11-21 are described with continued reference to the embodiments illustrated in FIGS. 1-10. However, FIGS. 11-21 are not limited to those embodiments.

In an embodiment, a client device 100 or a server 140 may include the exemplary interface illustrated in FIGS. 11-21. According to this embodiment, a client device 100 running the browser application 110 with an enhanced browser add-on 116 may display the exemplary interface illustrated in FIGS. 11-21 as part of user interface 112. Throughout FIGS. 11-21, displays are shown with various hyperlinks, command regions, tabs, buttons, checkboxes, and data entry fields, which are used to initiate action, invoke routines, enter data, view data, or invoke other functionality, such as functionality of the enhanced browser add-on 116 and the browser application 110. For brevity, only the differences occurring within the figures, as compared to previous or subsequent ones of the figures, are described below. By using an input device (not shown) or touch screen on a client device 100, a user can interact with the interface illustrated in FIGS. 11-21 to configure and manage the enhanced browser add-on 116.

FIG. 11 illustrates an exemplary browser engine selection interface 1100 for selecting a profile for a browser engine, such as a rendering engine 310. In the exemplary embodiment shown in FIG. 11, upon launching an administrative GUI for the enhanced browser add-on 116 browser engine selection interface 1100 can be displayed. As shown in FIG. 11, the browser engine selection interface 1100 includes dialog box 1102, which displays information regarding each of a plurality of recommended profiles 1104 and a plurality of advanced profiles 1106. FIG. 11 illustrates that an administrator or user can select one of the recommended profiles 1104 or the advanced profiles 1106. In the exemplary embodiment of FIG. 11, this selection can be made using an input device (not shown), pointing device (not shown) or touch screen to select a radio button corresponding to the desired profile. In the exemplary embodiment of FIG. 11, browser engine selection interface 1100 can be used to select profiles for IE Quirks, Adaptive IE Quirks (a combination of IE Quirks and IE7 Standards), Emulate IE7, Emulate IE8, Emulate IE9, IE7 Standards, IE8 Standards, IE9 Standards, IE Edge, a limited profile, and a blank profile (i.e., a profile with no browser engine).

Once a selection has been made, the user can click on an OK button 1108 to confirm the selection or click on a cancel button 1110 to cancel the selection.

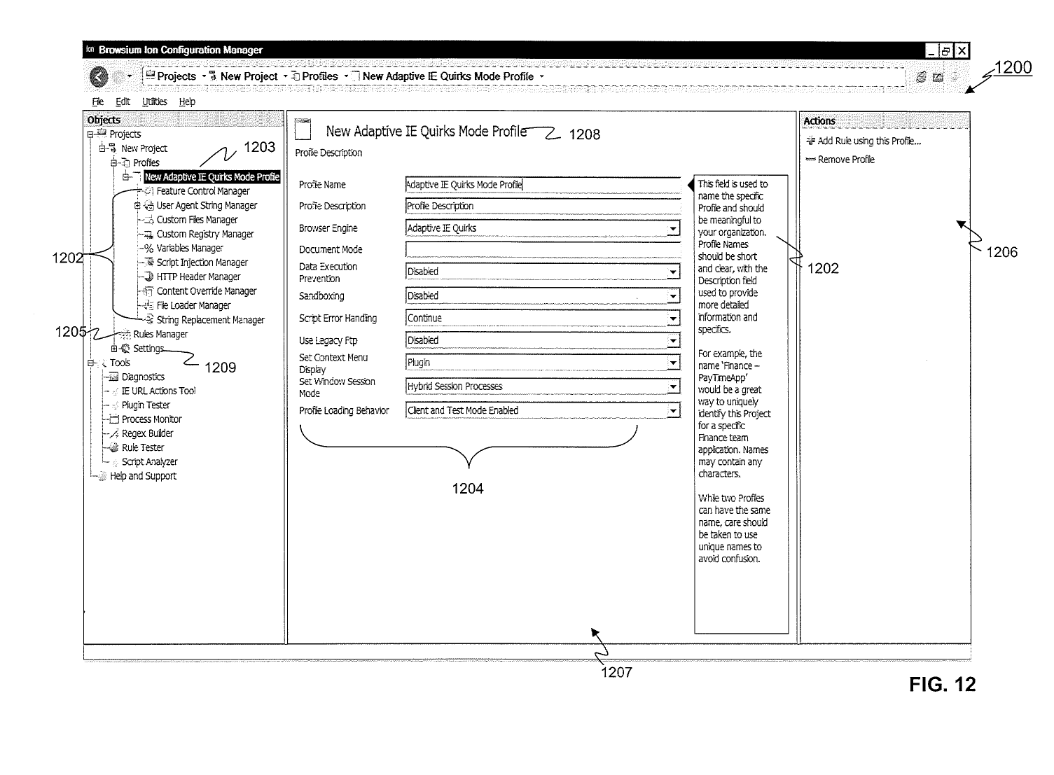

FIG. 12 illustrates an exemplary browser add-on 116 configuration management interface 1200 with a profile editor 1208. The configuration management interface 1200 includes an actions pane 1206 and a content pane 1207. The profile editor 1208 can be used to modify settings, values and configurations (shown as data entry fields 1204 in FIG. 12) for a given profile. Data entry fields 1204 can include, but are not limited to, profile detail fields such as Name, Description, Engine, etc. Profiles are assigned default values based on the Template selected when creating a New Profile with browser engine selection interface 1100. In an embodiment, most data entry fields 1204 can be left at default values, but the profile name and description are edited to reflect information and labeling relevant to a particular organization.

In the exemplary embodiment shown in FIG. 12, upon launching an administrative GUI for the enhanced browser add-on 116, the configuration management interface 1200 can be displayed with dialog box 1202 with a list of information regarding the data entry fields 1204 corresponding to a selected profile 1203. This list provides an explanation of each data entry field 1204 in the profile editor 1208. Additional information about each data entry field 1204 is provided below with reference one embodiment of the browser add-on 116 (e.g., the Browsium Ion implementation).

Profile Name—The Profile name is a friendly name for an administrator's reference, and can be modified to suit an organization.

Profile Description—The description field provides a place to include a more complete explanation of the Profile.

Browser Engine—The browser engine value determines the core engine used for the Profile.

Document Mode—In an embodiment, a browser add-on 116 such as Ion, allows an administrator to define which Document Mode is included for pages loaded using the specified Profile. IE Document Modes can be used to trigger different rendering and scripting engine behaviors. The default Document Mode included with each Profile is set based on the browser engine 310 selected when the Profile is created. The Document Mode can be changed at any time and is exclusive of the browser engine 310 value. In an embodiment, the selected profile 1203 is one of the recommended profiles 1104 or the advanced profiles 1106 selected using the browser engine selection interface 1100.

Data Execution Prevention (DEP)—the Ion browser add-on 116 enables granular management of DEP/NX settings for a specific profile rather than the entire IE process. Enabled by default on IE8, DEP/NX support enhances security by preventing an application or service from executing code from a non-executable memory region. The enhanced browser add-on 116 provides the ability to manage enhanced security settings for the DEP/NX feature. To disable DEP/NX support for the specific Profile, an administrator can simply click the checkbox in profile editor 1208.

Sandboxing—By default Sandboxing is set to ‘Disabled’ to ensure the broadest range of application compatibility needs. With Sandboxing Enabled, enhanced browser add-on 116 further increases browser security by reducing write access to the underlying operating system. When the enhanced browser add-on 116 process is closed, the memory is cleared and the content is no longer available. Ion tries to ensure that web applications will continue to work properly in a sandboxed environment while mitigating potential security issues if the end user loads malicious content. While this feature is disabled by default there are some instances where a web application may need to commit data to the operating or file system rather than delete it when the process is closed.

Script Error Handling—IE is designed to make page scripting ‘work’ even when errors are encountered. Some minor script errors (e.g. ‘unexpected values’) can be safely ignored and normal page rendering will occur. More serious scripting errors can cause the page to stop working or otherwise behave in an undesired way. According to an embodiment, Script Error Handling options include, but are not limited to the following:

Continue (Default): Do not show script errors (to the user); automatically select the ‘Continue’ option as if the user had selected it,

Halt: Do not show script errors (to the user), automatically select the ‘Cancel’ option as if the user had selected it; and

Show: Show script errors (to the user), allowing the user to decide how it should be handled.

Use Legacy FTP—The design of IE 6 was closely linked with Windows Explorer, so when FTP links were encountered by IE6 the user would see FTP handled seamlessly by Windows Explorer. For security reasons this design was deprecated and FTP connections were handled directly within the browser starting with Internet Explorer 7. The Use Legacy FTP data entry field 1204 emulates the legacy FTP behaviors and loads FTP connections in a Windows Explorer view, while still retaining the security enhancements of the new Internet Explorer process model.

Set Context Menu Display—A context menu is the menu which appears when a user right-clicks on a given object. IE has a specific context menu for each version of the program, and many 3rd-party web applications replace that context menu to provide extra functionality or application interactivity points for the user. By default, in an embodiment, the enhanced browser add-on 116 replaces the default IE context menu, as well as any 3rd-party web application context menus. The enhanced browser add-on 116 replaces the context menu to provide certain functionality and a consistent experience regardless of the browser engine being invoked. This feature enables control over whether to display the enhanced browser add-on 116 context menu or to defer to the browser for display of the built-in context menu or a 3rd-party web application custom context menu.

Set Window Session Mode—the enhanced browser add-on 116 provides the ability to directly manage session behavior for a given Profile, making it simple to ensure users can take advantage of a tabbed browsing experience while still accessing the applications they need, in the way they want. According to embodiments, available session modes, include, but are not limited to:

Shared: All tabs with content loaded by the same Profile will share cookies and session information;

Process Per Tab: Full session isolation where each tab that invokes a Profile does so through a separate process, so that session information isn't available outside that unique process; and

Hybrid Session Processes (Default): A combination of the Shared and Process Per Tab designed to balance stability and system resources. This feature works by sharing session information across a specified number of tabs as defined in the Maximum Pages per Process value in the Settings Node. When the maximum number of pages is reached, subsequent tabs will be assigned to a new process (e.g. until that process reaches its maximum) and new tabs will use new sessions. Tabs will remain in their respective process until all tabs associated with that process are closed.

Profile Loading Behavior—Profiles can be Enabled or Disabled to provide more granular management and resource loading behaviors. According to embodiments, there are several options to manage Profile Loading Behavior, including, but not limited to, the following:

Client Mode Enabled: Profile will be loaded only when used by a Rule;

Test Mode Enabled: Profile will be loaded on systems where the Admin Toolbar has been installed;

Client and Test Mode Enabled (Default): Profile will be loaded on Client systems if used by a Rule. In addition, the Profile will be loaded for machines with the Admin Toolbar installed; and

Disabled: Profile will never be loaded and cannot be triggered by any Rule match.

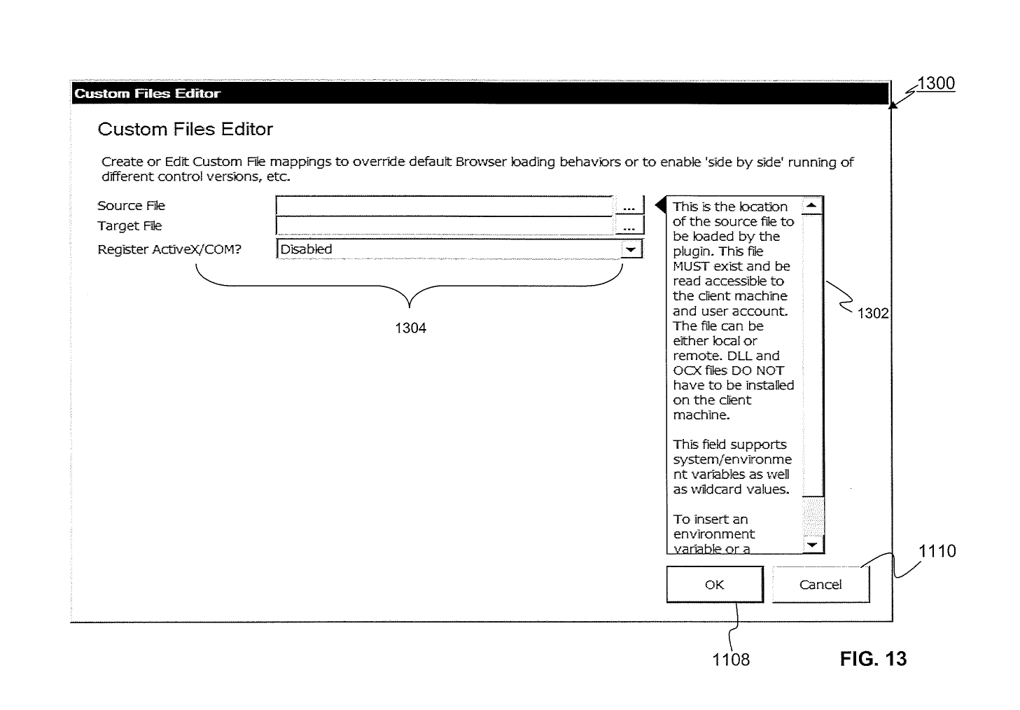

As shown in FIG. 12, the configuration management interface 1200 can be used to modify or remove a selected profile 1203 through use of various managers 1202, examples of which are described below with reference to FIGS. 13-16.

FIG. 12 also shows that the configuration management interface 1200 can be used to invoke a rules manager 1205. An exemplary GUI for rules manager 1205 is described below with reference to FIGS. 17 and 18.

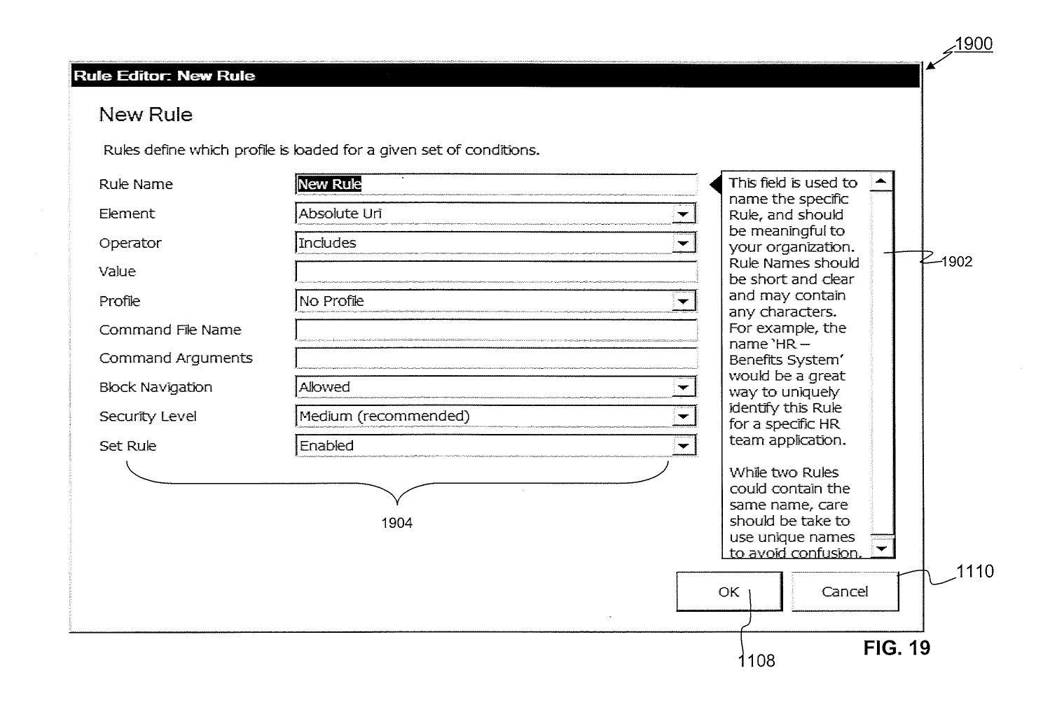

With continued reference to FIG. 12, the configuration management interface 1200 can be used to invoke a settings management tool 1209. An exemplary GUI for the settings management tool 1209 is described below with reference to FIG. 19.

FIG. 12 further illustrates that a user can add a rule or remove the selected profile 1203 using actions pane 1206.

FIG. 13 illustrates an exemplary custom files manager interface 1300. In the exemplary embodiment shown in FIG. 13, upon selecting the custom files manager from managers 1202 in the configuration management interface 1200, the custom files manager interface 1300 is launched and dialog box 1302 is displayed with information regarding custom file mapping data entry fields 1304.

In the Ion embodiment of browser add-on 116, an administrator or user can create specific file system entries as well as define custom ActiveX controls for a Profile. In one embodiment, Ion hosts these items internally, so nothing is applied or modified on the system. Any required file system entries or ActiveX controls can be defined using the custom files manager interface 1300.

As shown in FIG. 13, the custom files manager interface 1300 displays all configured Custom File and Custom ActiveX mappings. To add a value, an administrator can use a link in the actions pane 1206 or simply right click on the Custom Files Manager Node displayed with the managers 1202 and select the ‘Add Custom File’ option from a context menu (not shown). To edit a data entry field 1304, a user can highlight the data entry field 1304 in the content pane 1207 and use an ‘Edit Custom File’ link in the Actions Pane 1206 or a Custom Files Manager right-click context menu (not shown).

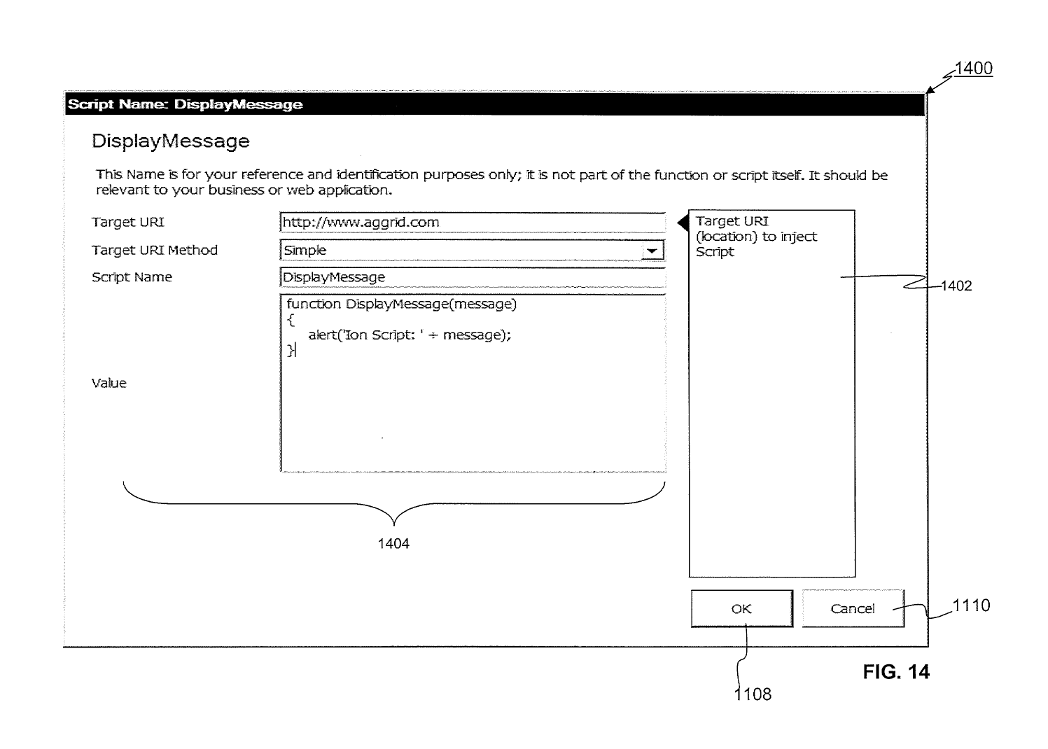

FIG. 14 illustrates an exemplary script injection editor 1400. In the exemplary embodiment shown in FIG. 14, the script injection editor 1400 allows administrators to create custom JavaScript functions or commands for a Profile. In the exemplary embodiment shown in FIG. 14, upon selecting the script injection manager from managers 1202 in the configuration management interface 1200, the script injection editor 1400 is launched and dialog box 1402 is displayed with information regarding script injection data entry fields 1404. For example, the exemplary implementation of browser add-on 116 (Ion) provides the ability to inject these scripts directly into a page, overriding any page-defined JavaScript behavior with this replacement version. As new versions of IE include different versions of the JavaScript engine, it may be necessary to modify a JavaScript function to ensure application compatibility for a given web application. For example, a site designed for IE6 may be able to run in a later version of Internet Explorer with only a few scripting tweaks. The JavaScript defined in the value data entry field 1404 is injected in the <head> tag of the document after the page loads and before the OnLoad event of the <body> tag is triggered.

The following HTML example of the scripts override feature provides an illustration of how to use the feature to replace a function. The following example HTML page includes a function (DisplayMessage) that displays an alert when the OnLoad event is triggered. In this embodiment, the HTML markup language is used to illustrate how to the script override feature can be used to replace a function. As would be appreciated by one of skill in the relevant arts, other programming languages and technologies can be used to implement the script override feature in the programming language code sample below.

<html>
<head>
<script type=“text/javascript”>
function DisplayMessage(message)
{
alert(message);
}
</script>
</head>
<body OnLoad=“DisplayMessage(‘Hello world’)”>
Page body.
</body>
</html>

To override the DisplayMessage function each time the above web HTML webpage is loaded by a given profile, an administrator, using the configuration management interface 1200, can click an ‘Add Script Injection Item’ link in the actions pane 1206 or use a Script Injection Manager right-click context menu option to open a Script Injection Editor window (not shown). Although the example above shows a single function, as would be appreciated by persons skilled in the relevant art, the Script can contain any number of functions or statements (up to an object size limit).

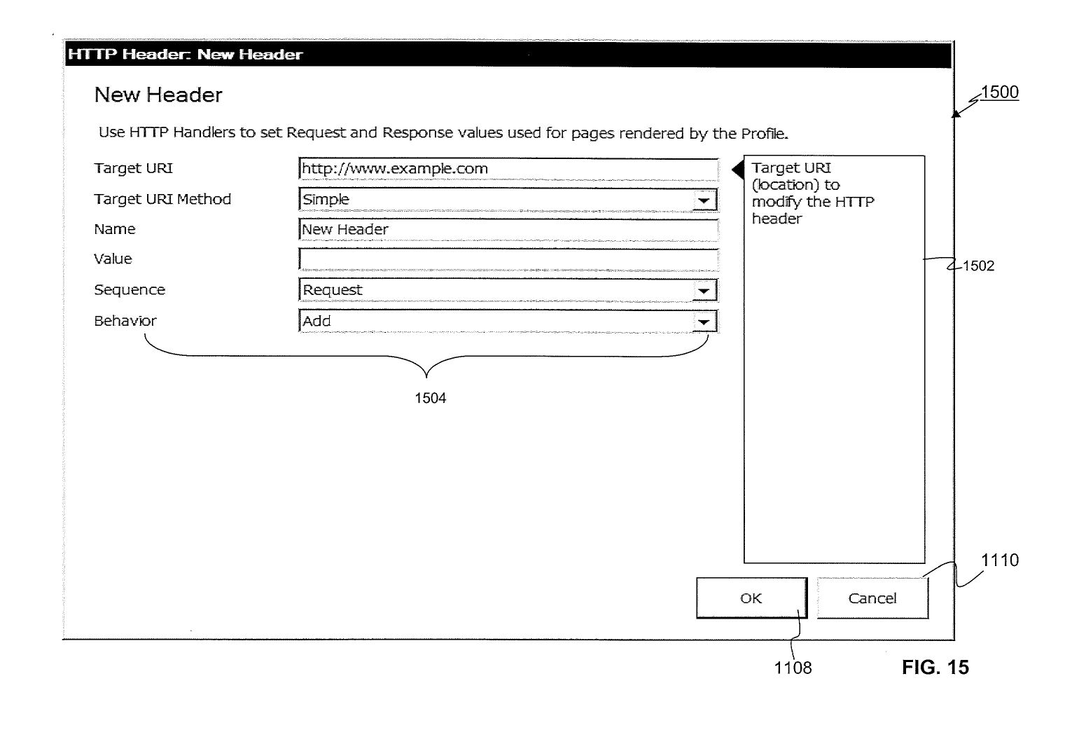

FIG. 15 illustrates an exemplary header manager interface 1500. In the exemplary embodiment shown in FIG. 15, upon selecting the header manager from managers 1202 in the configuration management interface 1200, the header manager interface 1500 is launched and dialog box 1502 is displayed with information regarding HTTP handler data entry fields 1504. The header manager interface 1500 can display a list of defined Custom HTTP headers. HTTP header fields are components of the message header of requests and responses and some web applications rely on these headers to trigger certain behaviors and functionality. In one embodiment, Ion enables creation and management of HTTP Headers

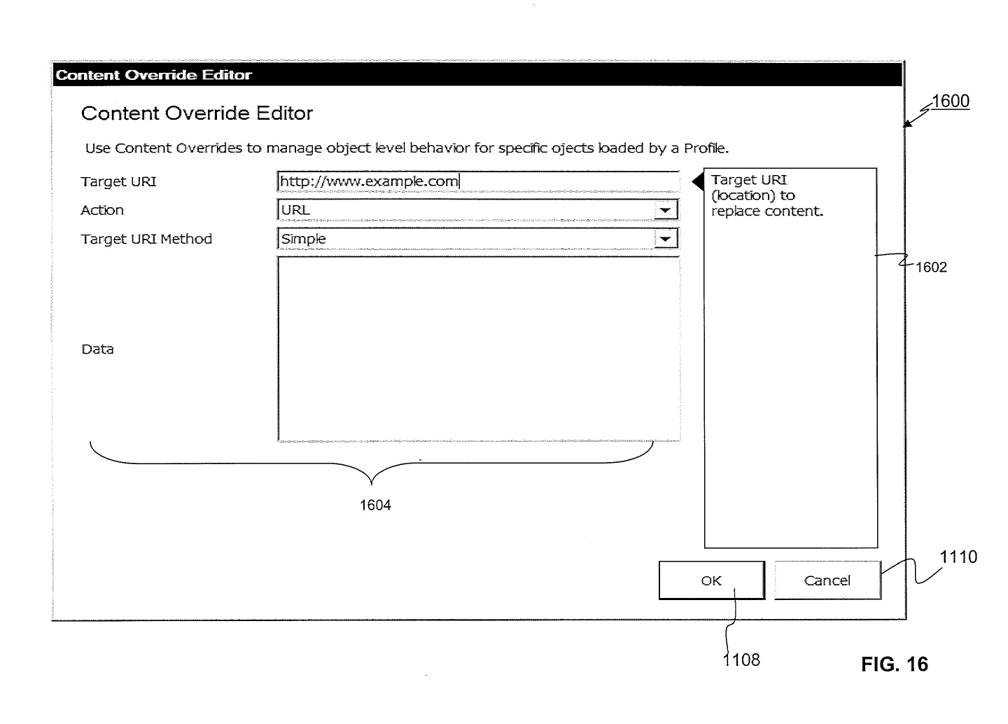

FIG. 16 illustrates an exemplary content override editor 1600. In the exemplary embodiment shown in FIG. 16, upon selecting the content override manager from managers 1202 in the configuration management interface 1200, the content override editor 1600 is launched and dialog box 1602 is displayed with information regarding content override data entry fields 1604. Some older web applications may include content (JavaScript, HTML, CSS, images, etc.) resulting in compatibility issues with newer browser rendering engines that cause the application to work incorrectly. These issues can be as simple as layout issues, more complex coding related issues that prevent the site from loading or even serious issues that cause the web browser to crash when loading specific content.

Through the use of the content override editor 1600, the enhanced browser add-on 116 provides the ability to replace or block inline or linked content for a given web page to help solve these compatibility issues. As shown in FIG. 16, an administrator can use the content override editor 1600 to define the Target URI—even though these settings are part of a Profile which would be triggered by a Rule. In an embodiment, content Overrides have an additional layer of granularity and work with content regardless of the location so the target URI must be specified for the content being replaced.

The Content Override feature provides the ability to control the loading behavior taken by the browser for the specified content. In accordance with embodiments, available Actions, include, but are not limited to:

Block: Stops the content from being downloaded;

URL(Default): Redirects the request for the content at the specified URI to the URL specified in the data field;

File: Loads content from the file specified in the Data field; and

Content: Replaces content from the specified URI with the content in the data field 1604.

In an embodiment, the ‘data field’ data entry field 1604 will contain content based on the selected action.

FIG. 17 illustrates an exemplary file loader interface 1700. In the exemplary embodiment shown in FIG. 17, upon selecting the file loader manager from managers 1202 in the configuration management interface 1200, the file loader interface 1700 is launched and dialog box 1702 is displayed with information regarding file loader data entry fields 1704. According to an embodiment, a File Loader feature of the exemplary browser add-on 116 provides support for web applications that need to render/load content in a full screen browser ActiveX controls when triggered by a specific file type—such as rendering a PDF file in a full page ADOBE™ Acrobat viewer. IE6 allowed for the ability to launch these full screen ActiveX controls by double clicking on an associated file on the user's machine. However, in IE8, this functionality is no longer supported and requires significant user retraining to get the expected behavior. Using the file loader interface 1700, administrators can create configurations for specific file types and select whether the corresponding ActiveX control is a full page control or served through an object tag on an HTML page. The Ion embodiment solves this issue and offers the ability to create a Rule that would load through the Ion File Loader executable.

At this point, double clicking on a file will launch a new IE instance and serve the specific file through the corresponding ActiveX viewer for the file type. An example would be configuring a File Loader entry for .pdf files (PDFs can be displayed either as a full page ActiveX controller or as an embedded ActiveX control on a page, but a full page control requires less configuration).

FIG. 18 illustrates an exemplary string replacement interface 1800. Some older web applications need simple, targeted fixes to make an application work exactly right. Often the issues can be as simple as resizing an image or changing a word in some JavaScript. Changing the web application source code is one solution—but many organizations are using ‘off the shelf’ applications for which they don't have source code access to change what is needed. Some commercial applications have license agreements that prohibit any modification to their source code or binaries. In addition, changing the source code is impractical for ‘roll outs’ where some users will remain on older browsers while some users get the latest versions.

In accordance with an embodiment, the enhanced browser add-on 116 offers the ability to edit text ‘inline’ before the browser rendering begins, enabling an organization to fix virtually any issue without touching the source code. These changes are highly targeted and can be used to make pinpoint changes to the affected area of the web application.

As shown in FIG. 18, in an embodiment, upon selecting the content string replacement manager from managers 1202 in the configuration management interface 1200, the string replacement interface 1800 is launched and dialog box 1802 is displayed with information regarding string replacement data entry fields 1804. In the exemplary embodiment of FIG. 18, the string replacement data entry fields 1804 can be used to determine what text in HTML, Cascading Style Sheets (CSS), and JavaScript files is replaced before a webpage is rendered so that an administrator or other user does not have to manually edit source code in such files. To make a string replacement using the string replacement interface 1800, a user starts by defining the Target URI. Even though these settings are part of a Profile which would be triggered by a Rule, String Replacements are designed to work with content regardless of the location so the Target URI must be specified for the strings being replaced. The user then enters the string to find in the ‘string to find’ data entry field 1804. According to embodiments, the pattern match can be EXACT or REGEX depending on the Method property selection (Simple or Regex/regular expression matching).

At this point, the user can enter the value to be used as the replacement text in the ‘replace with’ data entry field 1804 and click the OK button 1108 to finish.

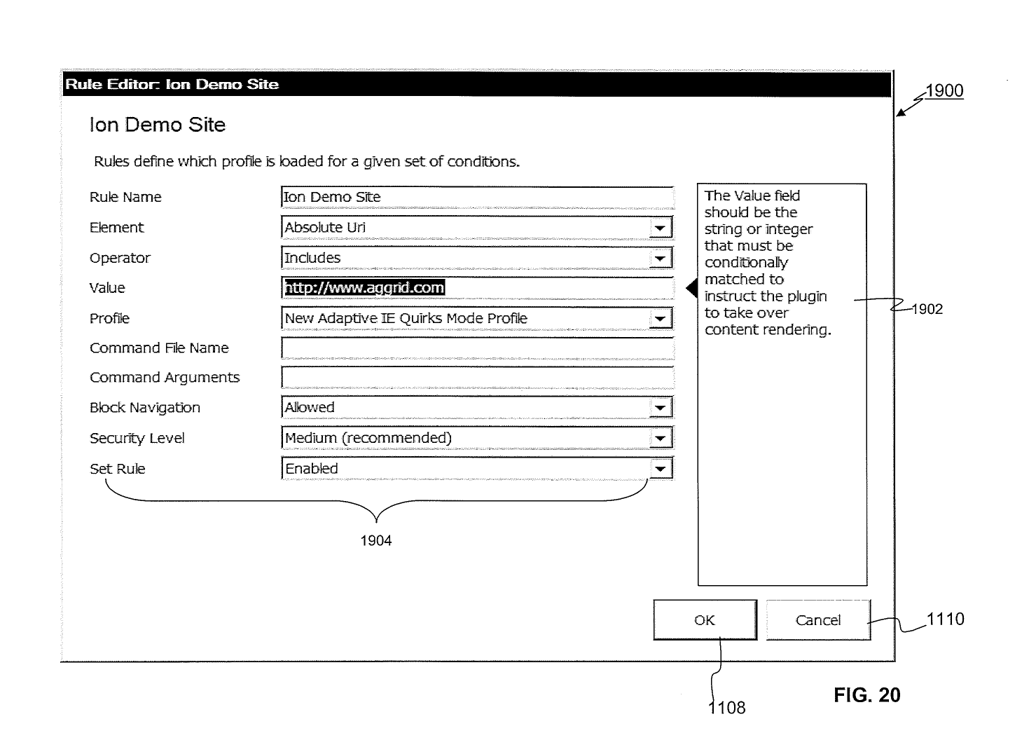

FIGS. 19 and 20 depict an exemplary rules editor 1900. The rules editor 1700 is the main rules management interface for creating, editing and managing evaluation criteria for which content is to be rendered using the browser add-on 116 (i.e., Ion).

As shown in FIG. 19, in an embodiment, upon selecting the rules manager 1205 in the configuration management interface 1200, the rules editor 1900 is launched. If a new rule is being created as a result of an add rule selection being made in actions pane 1206 of the configuration management interface 1200, and dialog box 1902 is displayed with information regarding rule data entry fields 1904. In the exemplary embodiment of FIG. 19, the rule data entry fields 1904 can be used to name, configure, and enable a newly-created rule.

The Content pane 1207 can display a hierarchical rules list that Ion can use to determine how to handle web application rendering. The heading for each column in this window refers to the specific rule element (e.g. Rule Name, Element, Operator, Value, etc.) for a given Rule. When no Rules are present, the actions pane 1206 only displays the ‘Add Rule’ link. As Rules are added, the actions pane 1206 will display additional links to manage ordering and editing Rules.

To create a new rule, a user can click the Add Rule link in the actions pane 1206 to bring up the rules editor 1900.

A user can name a rule using any characters without restriction or character count limit. Rule names are for an administrator's use and identification only, and have no impact on functionality.

Rule Elements are described in Table 1 below, which lists the various Elements on which Rules can be created.

TABLE 1
Rule Elements

| Type | Description | Example |
|---|---|---|
| Absolute | The entire canonical URI, | http://www.browsium.com/ |
| URI | including protocol scheme, | |
| | username, password, | |
| | hostname, domain, port, | |
| | path, query, | |
| | extension and fragment. | |
| Authority | Username, password, | user@host.browsium.com:9001 |
| | hostname, domain and port. | |
| Display | The protocol scheme, | http://www.browsium.com |
| URI | hostname, domain, port, | |
| | path, query and optionally, | |
| | fragment. | |
| Domain | The domain (including top | browsium.com |
| | level domain) only. Not for | |
| | use for intranet sites. (Use | |
| | “Host” instead.) | |
| Extension | The file extension of the | .html |
| | resource. | |
| Fragment | The information following a | #top |
| | fragment marker (#), | |
| | including the marker itself. | |
| | This can refer to named | |
| | anchors found within a | |
| | document. | |
| Host | The fully qualified domain | browsium.com or a filestore |
| | name or plain hostname. | |
| Password | The password, as parsed | Password |
| | from the URI. | |
| Path | The path and resource name. | /animals/birds |
| Path and | The path, resource name and | /animals/birds?robin |
| Query | query string. | |
| Query | The query string. (All text | ?robin |
| | following a ? in a URI) | |
| Raw URI | The entire URI as entered, | http://username:password@ |
| | including characters | hostn%61me.browsium.com |
| | represented as “%61” | |
| Scheme | The protocol scheme name. | http or ftp |
| Name | (The text preceding “://” in | |
| | an URI.) | |
| User Info | The username and password, | user:password |
| | as parsed from the URI. | |
| User | The username as parsed | User |
| Name | from the URI. | |
| Host Type | The type of host. | 2 (IPV4), 3 (IPV6) |
| Port | The port number. | 850 |
| Scheme | The scheme of the URI. | 2 (HTTP), 11 (HTTPS) |
| Zone | The zone of the URI. | 1 (INTRANET), |
| | | 3 (INTERNET)., etc. |

Table 2 below contains a brief explanation of each available Operator for rules.

TABLE 2
Rule Operators

| Conditional | Description |
|---|---|
| Is | Exactly matches the value field. |
| Is Not | Does not match the value field. |
| Less Than | Is less than and not equal to the value field. This |
| | conditional is especially useful with the Host, Port, |
| | Scheme and Zone rule types. |
| More Than | Is more than and not equal to the value field. This |
| | conditional is especially useful with the Host, Port, |
| | Scheme and Zone rule types. |
| Begins With | Starts with the string in the value field. |
| Ends With | Ends with the string in the value field. |
| Excludes | Does not contain the value field. |
| Includes | Contains the value field. |
| RegEx | Is determined by the regular expression in the value field. |

Additional data entry fields 1904 shown in FIGS. 19 and 20 are described below.

Value—this data entry field 1904 contains the string or integer to conditionally match in order to Ion to manage content rendering.

Profile—The Profile selection determines which browser Profile Ion uses to load the matching website. Any configured Profiles will be listed in this dropdown. In a default configuration there are no Profiles available. To change the Profile used for a given Rule, simply change the value in this field and save the configuration.

Command File Name—In an embodiment, Ion can be used to launch other applications or execute commands when Rule conditions are met. Simply enter the full path and filename of the command to execute. This field supports environment and system variables.

Command Arguments—Used in conjunction with the ability to launch applications or execute commands, this value is the argument that is passed to the command. A user can use the %1 variable to insert the target URL into the command arguments.

Block Navigation—Determine whether to continue standard page navigation when certain conditions are met. Using this feature an administrator could prevent content from being loaded.

Security Level—according to an embodiment, the enhanced browser add-on 116 can isolate content rendering and provides content loading behaviors in a secure manner. The default behavior for the enhanced browser add-on 116 to render only content matched by a Rule—all unmatched content navigations/loading will be cancelled. Table 3 below provides descriptions of the available security levels.

TABLE 3
security levels

| Security | |
|---|---|
| Level | Description |
| Low | Content is considered to match a Rule based on the value in |
| | the Address Bar (not based on each page elements unique |
| | URI). If the content of the Address Bar matches a Rule, all |
| | objects on the page will be rendered using the specified |
| | Profile. The enhanced browser add-on 116 will not evaluate |
| | subsequent navigation events (e.g. clicking a link, etc.) and |
| | will continue to render content using the same Profile |
| | until the tab is closed. |
| | Note: This setting should be used only when necessary. Since |
| | navigation events are not consistently evaluated, use of this |
| | setting could potentially result in a system being exposed to |
| | security threats if malicious content is accessed. |
| Medium | This is the default value for the setting. |
| | Content is considered to match a Rule based on the value in |
| | the Address Bar (not based on each page elements unique |
| | URI). If the content of the Address Bar matches a Rule, all |
| | objects on the page will be rendered using the specified |
| | Profile. The enhanced browser add-on 116 will treat |
| | subsequent navigation events (e.g. clicking a link) as ‘new’ |
| | navigations and perform a complete evaluation of the |
| | requested content. |
| High | Contents (individual page elements) are loaded only when a |
| | Rule is matched. If the content of the Address Bar matches a |
| | Rule, all objects on the page will be evaluated (and rendered |
| | if the specific object matches as well) using the specified |
| | Profile. The enhanced browser add-on 116 will treat |
| | subsequent navigation events (e.g. clicking a link, etc.) as |
| | ‘new’ navigations and perform a complete evaluation of the |
| | requested content. |

In one embodiment, by default, new Rules are set to a Medium security level.

The Set Rule data entry field 1904—Rules are enabled by default when they are created. Some Rules may contain complex parameters or complex paths and it may be more practical to simply disable a Rule rather than remove it if the Rule is not needed or to test ordering patterns, etc. In addition, some users may choose to keep only a single Rule set and want to disable a specific Rule for some given period of time. To disable a Rule, select ‘Disabled’ from the dropdown list or click the checkbox next to the Rule name in the rules editor 1900.

As shown in FIG. 20, the rules editor 1900 can also be used to edit an existing rule by changing values in the rule data entry fields 1904. As with the new rule example provided in FIG. 19, the dialog box 1902 displays information regarding the particular rule data entry field 1904 being edited by a user or administrator. As URLs and rule definitions can be complex, and complexity may lead to typographical errors, in the event an administrator makes a mistake or need to revise a Rule, the rules editor 1900 can be invoked by clicking the Edit Rule link in the actions pane 1206 to make the necessary changes.

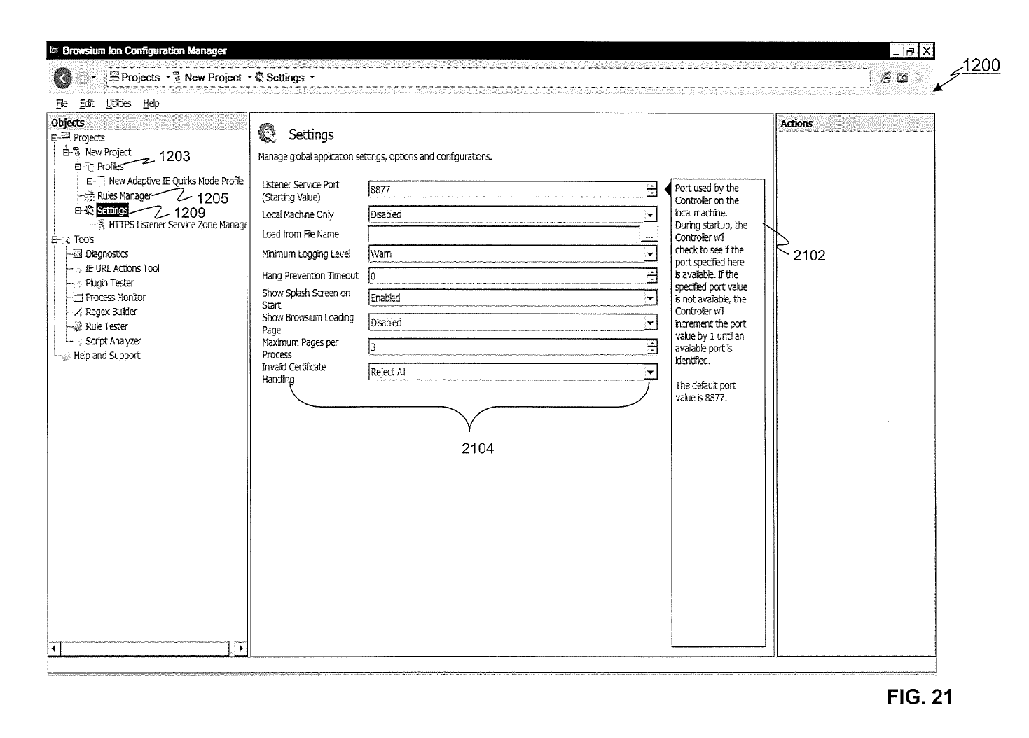

FIG. 21 illustrates an exemplary settings editor 2100. The settings editor 2100 gives an administrator or user the ability to edit global settings for the exemplary browser add-on 116 (e.g., Ion) configurations that will be applied to all Profiles. These settings encompass features such as the Listener Service Port, Hang Prevention, Profile Idle Resets, and generic security and loading behaviors.

In the exemplary embodiment shown in FIG. 21, upon selecting the settings tool 1209 in the configuration management interface 1200, the settings editor 2100 is launched and dialog box 2102 is displayed with information regarding settings data entry fields 2104. As shown in FIG. 21, the settings editor 2100 can be used by an administrator to manage global application settings, options, and configurations for the enhanced browser add-on 116.

The data entry fields 2104 are describe below with reference to the Ion embodiment of browser add-on 116.

Listener Service Port is the port used by the controller on the local machine, such as client device 100. During startup, the controller 308 will check to see if the specified port is available. If that port is not available, the controller 308 will automatically increment the port value by 1 until an available port is identified. According to an embodiment, the default port value is 8877.

Local Machine Only—by design, a Group Policy will allow values in a Current User (HKCU) hive to take precedence over values from a Local Machine (HKLM) hive. Some organizations may want to prevent values in HKCU from overriding HKLM Ion configuration values. By setting the Local Machine Only value to ‘Enabled,’ in one embodiment, Ion will restrict reading to only HKLM values.

Load from File Name—since Ion can be implemented as a client side solution with no server component (i.e., without server 140), getting the configuration settings to the client device 100 is critical for proper operation. Configuration management is extremely flexible and can be tailored to meet the design and requirements of an organization's environment. By default, Ion will look first in Group Policy for configurations, then Local Machine, then Current User. Table 4 below provides a hierarchy of precedence for how configuration values are evaluated and the locations being read.

TABLE 4
Hierarchy of precedence for configuration values

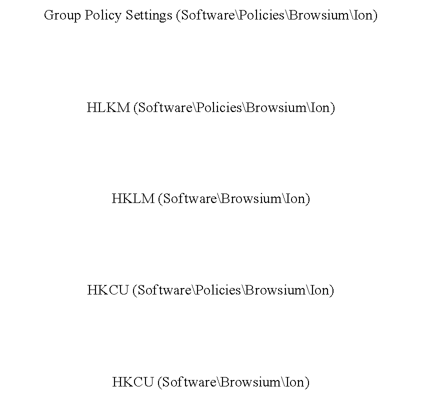

According to an embodiment, Ion will not look for a local (flat) file configuration by default. In order to instruct Ion to load configurations from a local file instead of the registry or policy values, a user must create two Project files—one Project that contains only a single reference to the location of the local file (that is defined in this setting), and another Project file that is the actual Project to be used by the organization. In embodiments, the path location value for the ‘actual’ Project file can be hard coded or declared with a system variable (using the $(variable) format notation). A user can use a Group Policy to deploy the ‘local file reference’ project file to user systems and use the preferred process for the target organization to deploy the ‘actual’ Project file to the specified location.

For organizations that do not use a Group Policy, local testing using the ‘Save local Settings’ option in the File menu to save the ‘local file reference’ project values to the administrator workstation. Once the values are saved to the local system, export the registry values from the location chosen in the ‘Save Local Settings’ dialog box (either ‘Current User’ or ‘Local Machine’).

Minimum Logging Level—In one embodiment, Ion records logging information to the standard Windows event log under an application-level source named, e.g., ‘Ion’. The Logging Level setting determines the amount and type of data collected in the Windows event log. Table 5 below summarizes the various levels and data collected.

TABLE 5
Logging Levels

| Level | Description |
|---|---|
| All | Writes Trace, Info, Warn, and Error entries |
| Info | Writes Info, Warn and Error entries |
| Warnings | Writes Warn and Error entries |
| Errors | Writes Error entries |

Hang Prevention Timeout—setting a value for the Hang Prevention Timeout data entry field 2104 enables an organization to automatically terminate a browser engine process if it goes longer than a predefined number of seconds without a response to the controller 308. According to an embodiment, the controller 308 will automatically re-launch the stopped process. A value of 0 or lower will turn off hang prevention. In an embodiment, the default setting for this feature is 0.

Show Browsium Loading Page—On older systems, or when using slower network connections or systems with limited memory, users may experience a moment of delay while Ion loads content and attaches to the IE frame. This data entry field 2104 allows administrators to control the display of the enhanced browser add-on 116 loading page to users while content is loaded.

Maximum Pages per Process—the Maximum Pages per Process data entry field 2104 represents the maximum number of pages the browser add-on 116 (i.e., Ion) will allow to run within a process. This value represents “parent” web pages; in IE 7 and higher parent pages are analogous to tabs. Parent tabs can have unlimited child windows within a process.

The design of IE 8 (and later) limits the number of web pages that can be opened in a single process. Loading too many tabs in a single process may cause Internet Explorer to crash. The Loosely Coupled Internet Explorer (LCIE) feature helps prevent users from seeing this limitation by spreading tabs throughout a number of processes.

Invalid Certificate Handling—when presented with invalid HTTPS Certificates, IE 6 did not generally warn users or prevent navigations. HTTPS Certificate handling behavior has become more secure in recent versions of Internet Explorer, such that invalid HTTPS Certificates will trigger blocked navigation, user prompts or related behaviors that prevent web applications from functioning as they did previously. The enhanced browser add-on 116 provides the ability to manage how invalid HTTPS Certificates are handled. According to embodiments, available options include, but are not limited to:

Reject All (Default): Rejects all invalid HTTPS Certificates and navigation is cancelled;

Prompt: User is prompted with a dialog to Accept or Reject an HTTPS Certificate; and

Allow All: Accept all invalid HTTPS Certificates and continue with navigation.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For instance, though rendering information using one version of a browser application over another is used in the exemplary examples, it is also possible that the rendering engine of one browser application can be used in conjunction with an entirely different browser.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs compiled on a computer, or equivalent electrical circuits, microcode, or the like. Furthermore, it has also proven convenient at times, to refer to these arrangements of operations as modules, without loss of generality. The described operations and their associated modules may be embodied in software compiled on a computer, firmware, hardware, or any combinations thereof.

### Computer System Implementation

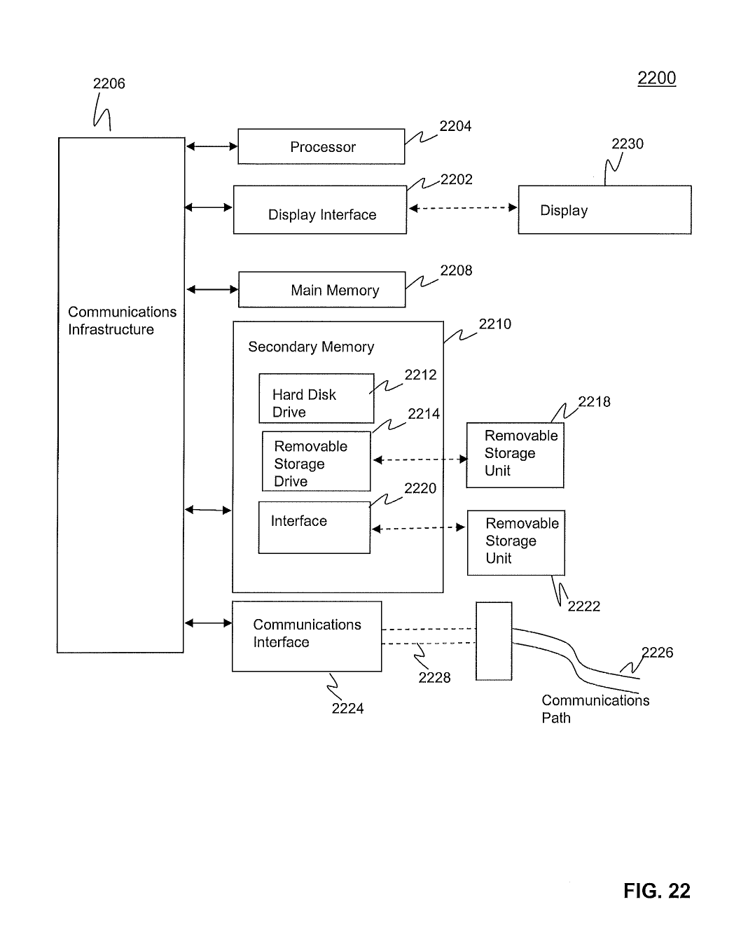

Although exemplary embodiments have been described in terms of a computer implemented method or apparatus, it is contemplated that it may be implemented by microprocessors of a computer, such as the computer system 2200 illustrated in FIG. 22. In various embodiments, one or more of the functions of the various components may be implemented in software that controls a computing device, such as computer system 2200, which is described below with reference to FIG. 22. The processor(s) of the computer system are configured to execute the software recorded on a non-transitory computer-readable recording medium, such as a hard disk drive, ROM, flash memory, optical memory, or any other type of non-volatile memory.

Aspects of the present disclosure shown in FIGS. 1-19, or any part(s) or function(s) thereof, may be implemented using hardware, software modules, firmware, tangible computer readable media having instructions stored thereon, or a combination thereof and may be implemented in one or more computer systems or other processing systems.

FIG. 22 illustrates an example computer system 2200 in which embodiments of the present disclosure, or portions thereof, may be implemented as computer-readable code. For example, the client device 100, the browser application 110, the enhanced browser add-on 116, the server 140, the web server 142, and the architecture 400 of FIGS. 1, 3 and 4, can be implemented in computer system 2200 using hardware, software, firmware, non-transitory computer readable media having instructions stored thereon, or a combination thereof and may be implemented in one or more computer systems or other processing systems. Hardware, software, or any combination of such may embody any of the modules and components used to implement the system components and architectures of FIGS. 1, 3 and 4. Similarly, hardware, software, or any combination of such may embody modules and components used to implement the methods of FIGS. 5-10 and graphical user interface (GUI) depicted in FIGS. 11-21.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 2200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 2204 may be a special purpose or a general purpose processor device. As will be appreciated by persons skilled in the relevant art, processor device 2204 may also be a single processor in a multi-core/multiprocessor system, such system operating alone, or in a cluster of computing devices operating in a cluster or server farm. Processor device 2204 is connected to a communication infrastructure 2206, for example, a bus, message queue, network, or multi-core message-passing scheme.

Computer system 2200 also includes a main memory 2208, for example, random access memory (RAM), and may also include a secondary memory 2210. Secondary memory 2210 may include, for example, a hard disk drive 2212, removable storage drive 2214. Removable storage drive 2214 may comprise a floppy disk drive, a magnetic tape drive, an optical disk drive, a flash memory, or the like.

The removable storage drive 2214 reads from and/or writes to a removable storage unit 2218 in a well known manner. Removable storage unit 2218 may comprise a floppy disk, magnetic tape, optical disk, etc. which is read by and written to by removable storage drive 2214. As will be appreciated by persons skilled in the relevant art, removable storage unit 2218 includes a non-transitory computer usable storage medium having stored therein computer software and/or data.

In alternative implementations, secondary memory 2210 may include other similar means for allowing computer programs or other instructions to be loaded into computer system 2200. Such means may include, for example, a removable storage unit 2222 and an interface 2220. Examples of such means may include a program cartridge and cartridge interface (such as that found in video game devices), a removable memory chip (such as an EPROM, or PROM) and associated socket, and other removable storage units 2222 and interfaces 2220 which allow software and data to be transferred from the removable storage unit 2222 to computer system 2200.

Computer system 2200 may also include a communications interface 2224. Communications interface 2224 allows software and data to be transferred between computer system 2200 and external devices. Communications interface 2224 may include a modem, a network interface (such as an Ethernet card), a communications port, a PCMCIA slot and card, or the like. Software and data transferred via communications interface 2224 may be in the form of signals, which may be electronic, electromagnetic, optical, or other signals capable of being received by communications interface 2224. These signals may be provided to communications interface 2224 via a communications path 2226. Communications path 2226 carries signals and may be implemented using wire or cable, fiber optics, a phone line, a cellular phone link, an RF link or other communications channels. In this document, the terms “computer program medium,” “non-transitory computer readable medium,” and “computer usable medium” are used to generally refer to media such as removable storage unit 2218, removable storage unit 2222, and a hard disk installed in hard disk drive 2212. Signals carried over communications path 2226 can also embody the logic described herein. Computer program medium and computer usable medium can also refer to memories, such as main memory 2208 and secondary memory 2210, which can be memory semiconductors (e.g. DRAMs, etc.). These computer program products are means for providing software to computer system 2200.

Computer programs (also called computer control logic) are stored in main memory 2208 and/or secondary memory 2210. Computer programs may also be received via communications interface 2224. Such computer programs, when executed, enable computer system 2200 to implement the present disclosure as discussed herein. In particular, the computer programs, when executed, enable processor device 2204 to implement the processes of the present disclosure, such as the stages in the methods illustrated by the flowcharts of FIGS. 5-10, discussed above. Accordingly, such computer programs represent controllers of the computer system 2200. Where the present disclosure is implemented using software, the software may be stored in a computer program product and loaded into computer system 2200 using removable storage drive 2214, interface 2220, and hard disk drive 2212, or communications interface 2224.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way. Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer implemented method for allowing a browser application running on a client device to access alternative versions of select portions of the browser application, the method comprising:
intercepting a navigation to a resource located by a requested uniform resource locator (URL);
evaluating properties of the resource located by the requested URL against one or more user- or computer-generated criteria or rules to determine whether an enhanced browser module is to continue processing the URL request or allow the URL request to proceed as it normally would without using the enhanced browser module,
wherein in response to determining that the resource located by the requested URL matches at least one of the one or more criteria or rules, the enhanced browser module renders the resource in accordance with the at least one of the one or more criteria or rules, and in response to determining that the resource located by the requested URL does not match at least one of the one or more criteria or rules, the enhanced browser module ceases operation within the navigation and relinquishes control of that navigation to the default browser originally handling the requested URL; and
processing information received from the resource located by the requested URL to display the content for the requested URL in a custom engine within the user interface (UI) constructs of a default or target browser.

2. The method of claim 1, wherein the resource is local.

3. The method of claim 1, wherein the resource is external.

4. The method of claim 1, wherein the resource is associated with an application.

5. The method of claim 4, wherein the application is one of a word processing application, a database application, an e-mail application, a graphics application, a spreadsheet application, or another generic application.

6. The method of claim 1, further comprising, prior to the intercepting, receiving a request to navigate to a resource by a URL.

7. The method of claim 1, wherein the enhanced browser module renders the resource based on inherent or derived properties and metadata of a document.

8. The method of claim 1, wherein the enhanced browser module renders the resource based on a document type declaration (DOCTYPE) for the resource, wherein the DOCTYPE is an instruction that associates the resource with a Document Type Definition (DTD).

9. The method of claim 8, wherein in response to determining that there is no text preceding the DOCTYPE in the resource, the enhanced browser module renders the resource using an Internet Explorer standard engine.

10. The method of claim 8, wherein in response to determining that the resource does not contain a DOCTYPE, contains a DOCTYPE expressly including a QUIRKS DOCTYPE declaration, or has text preceding the DOCTYPE, the enhanced browser module renders the resource using a Quirks mode engine.

11. A non-transitory computer readable storage medium having program instructions stored thereon for enabling a browser application running on a client device to access alternative versions of select portions of the browser application, the instructions comprising:
instructions for intercepting a navigation to a resource located by a requested uniform resource locator (URL);
instructions for evaluating properties of the resource located by the requested URL against one or more user- or computer-generated criteria or rules to determine whether an enhanced browser module is to continue processing the URL request or allow the URL request to proceed as it normally would without using the enhanced browser module,
wherein in response to determining that the resource located by the requested URL matches at least one of the one or more criteria or rules, the enhanced browser module renders the resource in accordance with the at least one of the one or more criteria or rules, and in response to determining that the resource located by the requested URL does not match at least one of the one or more criteria or rules, the enhanced browser module ceases operation within the navigation and relinquishes control of that navigation to the default browser originally handling the requested URL; and
instructions for processing information received from the resource located by the requested URL to display the content for the requested URL in a custom engine within the user interface (UI) constructs of a default or target browser.

12. The computer readable storage medium of claim 11, wherein the resource is associated with an application.

13. The computer readable storage medium of claim 11, wherein the application is one of a word processing application, a database application, an e-mail application, a graphics application, a spreadsheet application, or another generic application.

14. The computer readable storage medium of claim 11, the instructions further comprising, instructions for receiving a request to navigate to a resource by a URL.

15. The computer readable storage medium of claim 11, wherein the enhanced browser module renders the resource based on inherent or derived properties and metadata related to the location (URL) or delivery stream of the resource.

16. The computer readable storage medium of claim 11, wherein the enhanced browser module renders the resource based on a document type declaration (DOCTYPE) for the resource, wherein the DOCTYPE is an instruction that associates the resource with a Document Type Definition (DTD).

17. The computer readable storage medium of claim 16, wherein in response to determining that there is no text preceding the DOCTYPE in the resource, the enhanced browser module renders the resource using an Internet Explorer standard engine.

18. The computer readable storage medium of claim 16, wherein in response to determining that the resource does not contain a DOCTYPE, contains a DOCTYPE expressly including a QUIRKS DOCTYPE declaration, or has text preceding the DOCTYPE, the enhanced browser module renders the resource using a Quirks mode engine.

19. A system capable of allowing a browser application running on a client device to access alternative versions of select portions of the browser application, the system comprising:
a display module configured to present an interactive user interface in a display;
an intercepting module configured to intercept navigation to a resource located by a requested URL;
an evaluating module configured to evaluate properties of the resource located by the requested URL against one or more user- or computer-generated criteria or rules to determine whether an enhanced browser module is to continue processing the URL request or allow the URL request to proceed as it normally would without using the enhanced browser module,
wherein in response to determining that the resource located by the requested URL matches at least one of the one or more criteria or rules, the enhanced browser module renders the resource in accordance with the at least one of the one or more criteria or rules, and in response to determining that the resource located by the requested URL does not match at least one of the one or more criteria or rules, the enhanced browser module ceases operation within the navigation and relinquishes control of that navigation to the default browser originally handling the requested URL; and
a processing module configured to process information received from the resource located by the requested URL to display, on the display, the content for the requested URL in a custom engine within the user interface (UI) constructs of a default or target browser.

20. The system of claim 19, further comprising:
a navigating module configured to receive a request for a resource identified by a requested URL.

21. The system of claim 19, further comprising:
a configuration management module configured to create and maintain the one or more criteria or rules,
wherein the interactive user interface comprises an administrative interface configured to receive user input to create and modify the one or more criteria or rules.

22. The system of claim 21, wherein the administrative interface is further configured to receive user input to customize the custom engine.
